(19) United States
(12) Patent Application Publication
(10) Pub. No.: US 2013/0212015 A1
(43) Pub. Date: Aug. 15, 2013

(54) AVAILABLE BALANCE ENHANCEMENT

(71) Applicant: BANK OF AMERICA CORPORATION, (US)

(72) Inventors: Jennifer Kendrick Anthony, Charlotte, NC (US); Brent Beecher Allen, Charlotte, NC (US); Cynthia Dawn Washington Gilley, Fayetteville, GA (US); Andrew William Lester, Mill Valley, CA (US); Sheri Marie Tindall, Davidson, NC (US); Stephen Joseph Brunhuber, Charlotte, NC (US); Joyce Jacobson Reinhart, Benicia, CA (US)

(73) Assignee: BANK OF AMERICA CORPORATION, Charlotte, NC (US)

(21) Appl. No.: 13/834,046

(22) Filed: Mar. 15, 2013

Related U.S. Application Data
(63) Continuation-in-part of application No. 12/890,352, filed on Sep. 24, 2010.

(51) Int. Cl. G06Q 20/10

(52) U.S. Cl. CPC G06Q 20/108
USPC 705/42

(57) ABSTRACT

In some embodiments of the present invention, a method is provided that includes: (a) receiving information associated with a first transaction, where the first transaction involves a deposit account; (b) receiving information associated with a second transaction, where the second transaction involves the deposit account; (c) determining, based at least partially on the information associated with the first transaction, that an available balance associated with the deposit account is based at least partially on the first transaction; (d) determining, based at least partially on the information associated with the second transaction, that the available balance is not based on the second transaction; (e) posting first information to an online banking account, where the online banking account is associated with the deposit account, and where the first information indicates that the available balance is based at least partially on the first transaction; and (f) posting second information to the online banking account, where the second information indicates that the available balance is not based on the second transaction.

### CROSS REFERENCE TO RELATED APPLICATIONS

This application is a continuation-in-part of U.S. patent application Ser. No. 12/890,352 entitled “AVAILABLE BALANCE ENHANCEMENT” and filed on Sep. 24, 2010, the entire contents of which are incorporated by reference herein in its entirety.

### BACKGROUND

Today, many financial institution customers regularly use an online banking account to check their available balance, view transactions, pay bills, transfer funds, order checks, and/or perform one or more other tasks involving a deposit account. Indeed, more and more customers prefer using online banking accounts to manage their deposit accounts because it is often more convenient, less expensive, and less time-consuming than visiting a banking center or an automated teller machine (“ATM”). As a result, financial institutions that provide and/or maintain online banking accounts are constantly looking for new and innovative ways to improve them. Accordingly, there is a need to provide methods and apparatuses for improving online banking accounts and enhancing the online banking experience.

### SUMMARY OF SELECTED EMBODIMENTS OF THE PRESENT INVENTION

In general terms, embodiments of the present invention relate to methods and apparatuses for posting information to an online banking account, where the online banking account is associated with a deposit account, and where the posted information relates to the available balance associated with the deposit account. For example, in some embodiments, an available balance for the deposit account and transaction information associated with the deposit account are posted to a transaction ledger in the online banking account. In such embodiments, the transaction ledger is divided into two, easy-to-understand portions: an “Amount not included in Available Balance” portion and an “Amount included in Available Balance” portion. The Amount not included in Available Balance portion is meant to indicate that the available balance is not based on the transactions described therein. In other words, in such embodiments, the transaction amounts posted to the Amount not included in Available Balance portion are not included in the available balance and are not immediately available. Similarly, in such embodiments, the Amount included in Available Balance portion is meant to indicate that the available balance is based at least partially on the transactions described therein. In some embodiments, the transaction amounts posted to the Amount included in Available Balance portion are included in the available balance and are immediately available.

Some embodiments of the present invention provide a method that includes: (a) receiving information associated with a first transaction, where the first transaction involves a deposit account, where an authorization request submitted by a first merchant for the first transaction comprises a transaction amount that is less than the amount the first merchant will actually apply, and wherein the first transaction is not cleared; (b) receiving information associated with a second transaction, where the second transaction involves the deposit account, where an authorization request submitted by a second merchant comprises a transaction amount that is greater than the amount the second merchant will actually apply; (c) determining, based at least partially on the information associated with the first transaction, that an available balance associated with the deposit account is based at least partially on the first transaction and that a transaction amount associated with the first transaction is included in the available balance and is immediately available; (d) determining, based at least partially on the information associated with the second transaction, that the available balance is not based on the second transaction and that a transaction amount associated with the second transaction is not included in the available balance and is subject to a hold based on the number of deposits received in the deposit account during a period of time, wherein a total deposit amount of the received deposits is greater than a predetermined deposit maximum; (e) posting first information to an online banking account, where the online banking account is associated with the deposit account, and where the first information indicates that the available balance is based at least partially on the first transaction; and (f) posting second information to the online banking account, where the second information indicates that the available balance is not based on the second transaction.

In some embodiments, the method further includes: (a) determining the available balance associated with the deposit account; and (b) posting the available balance to the online banking account. In some embodiments of the method, the posting the first information includes: (a) posting a description of the first transaction to a first portion of the online banking account; and (b) posting information that indicates that the available balance is based at least partially on transactions described in the first portion of the online banking account. Additionally or alternatively, in some embodiments of the method, the posting the second information includes: (a) posting a description of the second transaction to a second portion of the online banking account; and (b) posting information that indicates that the available balance is not based on transactions described in the second portion of the online banking account. In some of these embodiments, the first portion of the online banking account includes a first portion of a transaction ledger in the online banking account, and the second portion of the online banking account includes a second portion of the transaction ledger.

In some embodiments of the method, the posting the first information includes: (a) posting a transaction amount associated with the first transaction to the online banking account; and (b) posting information proximate to the transaction amount that indicates that the transaction amount is included in the available balance. In some embodiments of the method, the posting the first information includes: (a) posting a transaction amount associated with the first transaction to a first portion of a transaction ledger in the online banking account; and (b) posting information to the online banking account that indicates that transaction amounts posted to the first portion of the transaction ledger are included in the available balance.

In some embodiments of the method, the first determining includes determining that a transaction amount associated with the first transaction is included in the available balance. Additionally or alternatively, in some embodiments, the second determining includes determining that a transaction amount associated with the second transaction is not included in the available balance. Also, in some embodiments, the first determining includes determining that a transaction amount associated with the first transaction is immediately available. In some embodiments, the second determining includes determining that a transaction amount associated with the second transaction is not immediately available.

In some embodiments of the method, the first determining is based at least partially on the type of the first transaction, and/or the second determining is based at least partially on the type of the second transaction. Additionally or alternatively, in some embodiments, the first determining is based at least partially on the status of the first transaction, and/or the second determining is based at least partially on the status of the second transaction. In some embodiments, the first determining is based at least partially on a party involved in the first transaction, and/or the second determining is based at least partially on a party involved in the second transaction. Also, in some embodiments, the first determining is based at least partially on a first merchant category code associated with the first transaction, and/or the second determining is based at least partially on a second merchant category code associated with the second transaction.

In some embodiments, the second determining is based at least partially on determining that the second transaction is subject to a hold. Additionally or alternatively, in some embodiments, the first determining is based at least partially on determining that the first transaction involves an under-authorizing merchant. In some embodiments, the second determining is based at least partially on determining that the second transaction involves an over-authorizing merchant.

In some embodiments of the method, the first determining is based at least partially on: (a) determining that the first transaction includes a deposit transaction; (b) determining that the deposit transaction includes a total deposit amount; and (c) determining that at least a portion of the total deposit amount is immediately available. In other embodiments, the second determining is based at least partially on: (a) determining that the second transaction includes a deposit transaction; (b) determining that the deposit transaction includes a total deposit amount; and (c) determining that none of the total deposit amount is immediately available.

Other embodiments of the present invention provide a system for enhancing financial account balances. In some embodiments, the system includes a computer apparatus including a processor and a memory; and a transaction software module stored in the memory, comprising executable instructions that when executed by the processor cause the processor to receive information associated with a first transaction, wherein the first transaction involves a deposit account, wherein an authorization request submitted by a first merchant for the first transaction comprises a transaction amount that is less than the amount the first merchant will actually apply, and wherein the first transaction is not cleared. In some embodiments, the processor is further configured to receive information associated with a second transaction, wherein the second transaction involves the deposit account, wherein an authorization request submitted by a second merchant comprises a transaction amount that is greater than the amount the second merchant will actually impose. In some embodiments, the processor is further configured to determine, based at least partially on the information associated with the first transaction, that an available balance associated with the deposit account is based at least partially on the first transaction and that a transaction amount associated with the first transaction is included in the available balance and is immediately available. In some embodiments, the processor is further configured to determine, based at least partially on the information associated with the second transaction, that the available balance is not based on the second transaction and that a transaction amount associated with the second transaction is not included in the available balance and is subject to a hold based on the number of deposits received in the deposit account during a period of time, wherein a total deposit amount of the received deposits is greater than a predetermined deposit maximum. In some embodiments, the processor is further configured to post first information to an online banking account, wherein the online banking account is associated with the deposit account, and wherein the first information indicates that the available balance is based at least partially on the first transaction. In some embodiments, the processor is further configured to post second information to the online banking account, wherein the second information indicates that the available balance is not based on the second transaction.

Still other embodiments of the present invention provide a computer program product that includes a non-transitory computer-readable medium. In some embodiments, the computer-readable medium includes one or more computer-executable program code portions that, when executed by a computer, cause the computer to: (a) receive information associated with a first transaction, where the first transaction involves a deposit account; (b) receive information associated with a second transaction, where the second transaction involves the deposit account; (c) determine, based at least partially on the information associated with the first transaction, that an available balance associated with the deposit account is based at least partially on the first transaction; (d) determine, based at least partially on the information associated with the second transaction, that the available balance is not based on the second transaction; (e) post first information to an online banking account, where the online banking account is associated with the deposit account, and where the first information indicates that the available balance is based at least partially on the first transaction; and (f) post second information to the online banking account, where the second information indicates that the available balance is not based on the second transaction.

### BRIEF DESCRIPTION OF THE DRAWINGS

Having thus described some embodiments of the present invention in general terms, reference will now be made to the accompanying drawings, wherein:

FIG. 1 is a flow diagram illustrating a general process flow for posting available balance information to an online banking account, in accordance with an embodiment of the present invention;

FIG. 2 is a flow diagram illustrating a general process flow for posting available balance information to an online banking account, where the available balance information is associated with a merchant transaction, in accordance with an embodiment of the present invention;

FIG. 3 is a flow diagram illustrating a general process flow for posting estimated balance information to an online banking account, in accordance with an embodiment of the present invention;

FIG. 4 is a flow diagram illustrating a general process flow for posting available balance and/or estimated balance information to an online banking account, where the available balance and/or estimated balance information is associated with a deposit transaction, in accordance with an embodiment of the present invention;

FIG. 5 is a flow diagram illustrating a general process flow for posting deposit transaction-level information to an online banking account, in accordance with an embodiment of the present invention;

FIG. 6 is a block diagram illustrating a system for posting available balance information, estimated balance information, and/or deposit transaction-level information to an online banking account, in accordance with an embodiment of the present invention;

FIG. 7 is a mixed block and flow diagram illustrating a system for posting information to an online banking account, in accordance with an embodiment of the present invention; and

FIG. 8 illustrates an exemplary browser page of an online banking account associated with a checking account, where the browser page includes available balance information, estimated balance information, and deposit transaction-level information associated with the checking account, in accordance with an embodiment of the present invention.

### DETAILED DESCRIPTION OF EMBODIMENTS OF THE PRESENT INVENTION

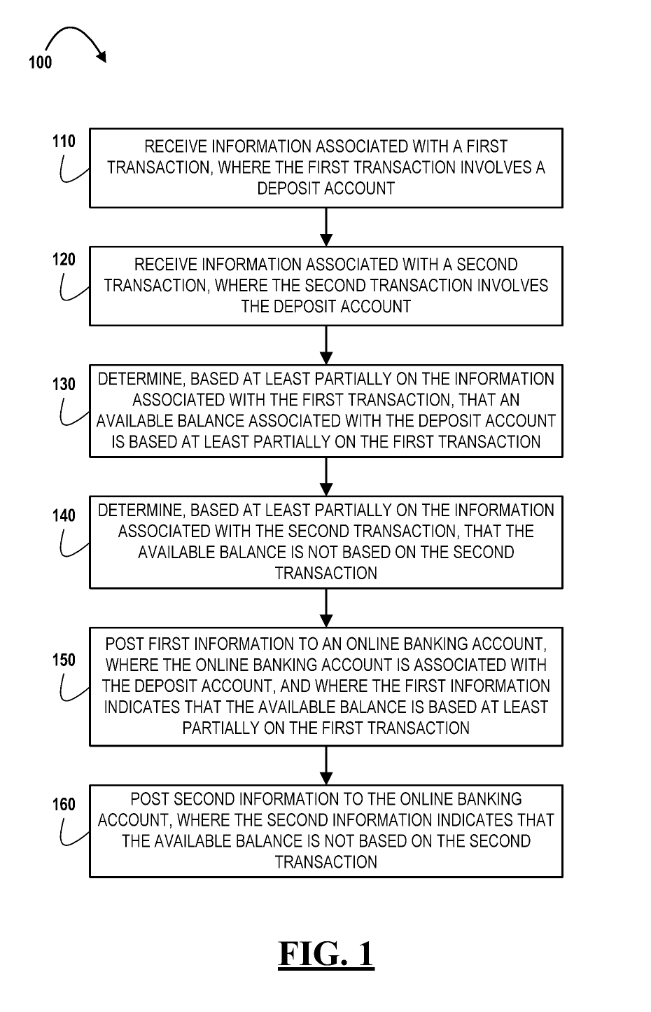

Referring now to FIG. 1, a general process flow 100 for posting available balance information to an online banking account is provided, in accordance with an embodiment of the present invention. In some embodiments, the process flow 100 is performed by an apparatus having hardware and/or software configured to perform one or more portions of the process flow 100. In such embodiments, as represented by block 110, the apparatus is configured to receive information associated with a first transaction, where the first transaction involves a deposit account. As represented by block 120, the apparatus is also configured to receive information associated with a second transaction, where the second transaction involves the deposit account. As represented by block 130, the apparatus is configured to determine, based at least partially on the information associated with the first transaction, that an available balance associated with the deposit account is based at least partially on the first transaction. As represented by block 140, the apparatus is also configured to determine, based at least partially on the information associated with the second transaction, that the available balance is not based on the second transaction. As represented by block 150, the apparatus is configured to post first information to an online banking account, where the online banking account is associated with the deposit account, and where the first information indicates that the available balance is based at least partially on the first transaction. As represented by block 160, the apparatus is also configured to post second information to the online banking account, where the second information indicates that the available balance is not based on the second transaction.

For simplicity, the information associated with the first transaction is sometimes referred to herein as “first transaction information,” and the information associated with the second transaction is sometimes referred to herein as “second transaction information.” Also for simplicity, the portion of the process flow 100 represented by block 130 is sometimes referred to herein as the “first determining” or “first determination,” and the portion represented by block 140 is sometimes referred to herein as the “second determining” or “second determination.”

It will be understood that the apparatus configured to perform the process flow 100 illustrated in FIG. 1 (and/or any of the apparatuses described and/or contemplated herein) can include and/or be embodied as one or more separate and/or different apparatuses. For example, in some embodiments of the invention, one apparatus is configured to perform the portions of the process flow 100 represented by blocks 110-140, and a second apparatus is configured to perform the portions represented by blocks 150 and 160. However, in other embodiments, a single apparatus is configured to perform each and every portion of the process flow 100. In addition, in some embodiments, a first portion of an apparatus is configured to perform one or more portions of the process flow 100, and one or more other portions of the same apparatus are configured to perform the one or more other portions of the process flow 100.

Regarding blocks 110 and 120, the deposit account can include and/or be embodied as a checking account, savings account, money market account, investment account, brokerage account, and/or any other kind of account that can have an available balance. In some embodiments, the deposit account exceeds the available funds in the account. Also, the first transaction and the second transaction can include any number and/or type of transaction(s) involving a deposit account. Exemplary transactions include, but are not limited to: purchasing, renting, selling, and/or leasing one or more goods and/or services (e.g., merchandise, groceries, tickets, and the like); withdrawing cash; making deposits; making payments to a creditor (e.g., paying bills; paying taxes; and the like); sending remittances; transferring funds; wiring funds; loading money onto a stored value card; and/or the like.

In some embodiments of the invention, the first transaction and the second transaction can be the same type of transaction, but in other embodiments, the first transaction is different than the second transaction. The transaction type may be described based at least partially on the one or more goods and/or services involved in the transaction (e.g., withdrawing cash, purchasing merchandise, transferring funds, and the like), the one or more parties involved in the transaction (e.g., account holder, bank, teller, merchant, and the like), the one or more devices involved in, and/or sources of, the transaction (e.g., point-of-sale (“POS”) device, ATM, teller terminal, and the like), the one or more ways in which the transaction is carried out (e.g., paper checks, wire transfers, online bill pay, automated clearing house (ACH), contactless payments, cash payments, and the like), when the transaction occurred (e.g., time of day, day of week, and the like), and/or the like. Also, the transaction can be described by the status of the transaction, such as, for example, whether the transaction is processing and/or has been initiated, authorized, pending, held, delayed, posted, cleared, finalized, reconciled, and/or the like. In some embodiments, two or more of these status terms mean the same thing. For example, in some embodiments described herein, the status “finalized” means “cleared” and vice versa. However, in other embodiments, these status terms may mean different things, such as, for example, when a “cleared” transaction is not technically “finalized” because it can be reversed.

Further regarding blocks 110 and 120, the first transaction information and the second transaction information can include any amount and/or type of information. In some embodiments, transaction information includes any information that identifies, defines, describes, and/or is otherwise associated with one or more transactions. Exemplary transaction information includes, but is not limited to, the type of the transaction (e.g., deposit transaction, withdrawal transaction, POS device transaction, ATM transaction, merchant transaction, and the like), the status of the transaction (e.g., held, authorized, processing, finalized, and the like), the party(ies) involved in the transaction, the date and/or time of the transaction, the posting date of the transaction, the account(s) involved in the transaction, the transaction amount(s) associated with the transaction, the good(s) and/or service(s) involved in the transaction, a description of the transaction (which, itself, can include any transaction information, i.e., the description may describe the transaction type, transaction status, the goods and/or services involved in the transaction, and the like), and/or the like. In some embodiments, the transaction information additionally or alternatively includes information indicating whether the available balance is based at least partially on the transaction or whether the available balance is not based on the transaction.

In some embodiments, the transaction information additionally or alternatively identifies and/or describes one or more merchant category codes associated with the transaction. As used herein, the phrase “merchant category code” generally refers to a number assigned to a merchant by a financial institution, where the number is used to classify the merchant by the type of goods and/or services the merchant provides. In some embodiments, the merchant category code is a four digit number assigned by a credit card provider, which, in some embodiments, is a bank. Exemplary merchant category codes include “5814” for fast food restaurants, “5933” for pawn shops, “8062” for hospitals, “5411” for grocery supermarkets, and “3501” for hotels. A merchant category code may generally refer to the goods and/or services provided by a merchant (e.g., hospital, fast food restaurant, and the like) and/or may specifically identify the name of an individual merchant. In other words, individual industries and/or individual merchants can have their own merchant category codes.

Further regarding blocks 110 and 120, the apparatus can be configured to receive the first transaction information and/or the second transaction information in any way. In some embodiments, the apparatus is configured to receive an authorization request associated with the first transaction, where the authorization request includes the first transaction information. For example, in some embodiments, the apparatus is an apparatus provided, serviced, operated, controlled, managed, and/or maintained (collectively referred to herein as “maintained” for simplicity) by a financial institution, and the apparatus is configured to approve and/or decline authorization requests for debit transactions, ATM transactions, POS device transactions, and/or one or more other types of transactions that involve one or more accounts maintained by the financial institution.

Additionally or alternatively, the apparatus can be configured to receive the first transaction information and/or the second transaction information directly or indirectly from the source of the transaction. For example, in some embodiments, where the transaction involves a transaction machine, the apparatus is located remotely from the transaction machine but is operatively connected to the transaction machine via a network. As another example, in some embodiments, where the transaction involves a transaction machine, the apparatus may include the transaction machine. For example, where the transaction involves a cash withdrawal at an ATM, the apparatus configured to perform the process flow 100 is embodied as the ATM.

Regarding blocks 130 and 140, the phrase “available balance,” as used herein, generally refers to an amount of funds in a deposit account that is immediately available (e.g., to an account holder, to cover debit transactions, for withdrawal, and the like). The available balance typically includes one or more transaction amounts from one or more transactions involving the deposit account. However, the available balance may not include every transaction amount from every transaction involving the deposit account. For example, in some embodiments, the available balance does not include transaction amounts from transactions that are subject to holds. As another example, in some embodiments, the available balance is not based on transactions unknown to the financial institution maintaining the deposit account, such as, for example, where the deposit account is a checking account, the account holder has written a check to a payee, and the payee has not yet deposited the check at the payee's financial institution. The phrase “available balance” is sometimes referred to herein as, and is meant to be synonymous with, “an amount currently available” and/or an “amount available now.”

Further regarding blocks 130 and 140, the apparatus can make the first determination and the second determination in any way. In some embodiments, the first determination includes determining that a transaction amount associated with the first transaction is included in the available balance. For example, in some embodiments, where the first transaction includes a deposit transaction of $100, the apparatus is configured to make the first determination by determining that the $100 from the deposit transaction is included in the available balance associated with the deposit account. Similarly, in some embodiments, the apparatus is configured to make the second determination by determining that a transaction amount associated with the second transaction is not included in the available balance.

In some embodiments, the apparatus is configured to make the first and/or second determination based at least partially on the type of the first and/or second transaction. For example, in some embodiments, the apparatus is configured to make the first determination based at least partially on determining that the first transaction is a cash deposit transaction. As another example, in some embodiments, the apparatus is configured to make the second determination based at least partially on determining that the second transaction is a deposit transaction subject to a hold. As still another example, in some embodiments, the apparatus is configured to make the first determination based at least partially on determining that the first transaction involved a teller and/or a teller machine. As still another example, in some embodiments, the apparatus is configured to make the second determination based at least partially on determining that the second transaction was performed at an ATM.

Additionally or alternatively, in some embodiments, the apparatus configured to perform the process flow 100 is configured to make the first and/or second determination based at least partially on the status of the first and/or second transaction. For example, in some embodiments, the apparatus is configured to make the first determination based at least partially on determining that the first transaction has been finalized. As another example, in some embodiments, the apparatus is configured to make the second determination based at least partially on determining that the second transaction has been initiated but not authorized. As still another example, in some embodiments, the apparatus is configured to make the first determination based at least partially on determining that the first transaction has been authorized but not finalized. In some embodiments, where a bank maintains the apparatus and the first transaction involves a merchant, the apparatus can be configured to make the first determination based at least partially on determining that the bank has authorized the first transaction but the merchant has not provided the bank with the final transaction amount.

Further regarding blocks 130 and 140, in some embodiments, the apparatus configured to perform the process flow 100 is configured to make the first and/or second determination based at least partially on one or more parties involved in the first and/or second transaction. For example, in some embodiments, the apparatus is configured to make the first determination based at least partially on determining that the first transaction involves a restaurant, gas station, and/or one or more other “under-authorizing” merchants. As used herein, the phrase “under-authorizing merchant” generally refers to a merchant that typically submits an authorization request for a transaction amount that is less than what the merchant will actually impose. For example, in the United States, restaurant customers typically add a voluntary, extra payment to their bill (called a “tip”) in order to, for example, reward a waiter for providing a service. However, when the customer intends to pay both the bill and tip using a debit card, the tip is usually added to the bill after the customer's card has been swiped at a POS device to verify that a deposit account associated with the card has adequate funds to pay the bill. If the account has adequate funds, then the merchant receives authorization from the financial institution that maintains the account to proceed with the transaction. However, because the restaurant is an under-authorizing merchant, this authorized amount is almost always less than what the restaurant will actually apply to the account (because of the addition of the tip). As a result, in some embodiments, the apparatus configured to perform the process flow 100 is configured to include the authorized (lesser) amount in the available balance associated with the deposit account (i.e., deduct the authorized amount from the available balance) since at least that authorized amount is likely to be applied to the deposit account.

As another example, in some embodiments, the apparatus is configured to make the second determination based at least partially on determining that the second transaction involves a hotel, airline, rental car company, and/or one or more other “over-authorizing” merchants. As used herein, the phrase “over-authorizing merchant” generally refers to a merchant that typically submits an authorization request for a transaction amount that is greater than what the merchant will actually impose. For example, in the United States, hotels typically add any extra payments (e.g., in-room movies, room service, and the like) incurred by a customer at the end of the customer's stay with the hotel. In order to ensure that the customer has adequate funds to cover these extra payments, the hotel may submit an authorization request to the customer's financial institution, at the beginning of the customer's stay, for an amount that is greater than the payments associated with the customer's room. For example, if the hotel is going to give the customer a bill of $800 for a three-night stay, then the hotel may, when the customer checks into the hotel, submit an authorization request to the customer's financial institution for $1,000 in order to cover any extra payments that the customer may incur during his or her stay. As a result, in some embodiments, the apparatus configured to perform the process flow 100 is configured to not include the authorized (greater) amount in the available balance associated with the deposit account (i.e., not deduct the authorized amount from the available balance) since that authorized amount may not be the final amount applied to the deposit account.

Further regarding blocks 130 and 140, in some embodiments, the apparatus is configured to make the first and/or second determination based at least partially on one or more merchant category codes associated with the first and/or second transaction. For example, in some embodiments, the apparatus is configured to make the first determination based at least partially on determining that the first transaction is associated with the merchant category code “5812” for Eating Places and Restaurants. As another example, in some embodiments, the apparatus is configured to make the second determination based at least partially on determining that the second transaction is associated with the merchant category code “3000” for an airline.

In some embodiments, the apparatus includes and/or is operatively connected to a datastore that stores one or more merchant category codes, rules, and/or other information therein. For example, in some embodiments, an exemplary rule may specify that an available balance for a deposit account is not based on any transaction associated with a first merchant category code, but that the available balance is based at least partially on any transaction associated with a second merchant category code. Thus, in some embodiments, the apparatus is configured access the datastore and make the first and/or second determination based at least partially on determining that the first and/or second transaction is associated with a first and/or second merchant category code. In some embodiments, the apparatus is configured to make the first determination based at least partially on determining that the first transaction is associated with a particular merchant category code that is included in the datastore and/or make the second determination based at least partially on determining that the second transaction is associated with a second merchant category code that is not included in the datastore.

In other embodiments, the datastore stores two lists of merchant category codes therein, where the first list includes merchant category codes for transactions that affect the available balance of a deposit account, and where the second list includes merchant category codes for transactions that do not affect the available balance of a deposit account. As a result, in such embodiments, the apparatus configured to perform the process flow 100 can be configured to make the first determination based at least partially on determining that the first transaction is associated with a merchant category code included in the first list and/or make the second determination based at least partially on determining that the second transaction is associated with a merchant category code included in the second list. Also, in some embodiments, the first list includes merchant category code(s) associated with one or more under-authorizing merchants, and/or the second list includes merchant category code(s) associated with one or more over-authorizing merchants. Also, in some embodiments, the datastore can be periodically, continually, continuously, and/or dynamically updated, revised, and/or otherwise changed. In some embodiments, a financial institution can, for example, dynamically update the merchant category codes and/or rules stored in the datastore, thereby enabling the financial institution to quickly and easily update which merchant transactions do and do not affect the available balance for a deposit account.

Further regarding blocks 130 and 140, the apparatus can be configured to make the first and/or second determination based at least partially on whether the available balance is, in fact, based at least partially on the first and/or second transaction. For example, in some embodiments, the apparatus is configured to make the first determination based at least partially on: (a) determining that the first transaction includes a deposit transaction; (b) determining that the deposit transaction includes a total deposit amount; and (c) determining that at least a portion of the total deposit amount is immediately available. Additionally or alternatively, in some embodiments, the apparatus is configured to make the second determination based at least partially on: (a) determining that the second transaction includes a deposit transaction; (b) determining that the deposit transaction includes a total deposit amount; and (c) determining that none of the total deposit amount is immediately available. As another example, in some embodiments, the apparatus is configured to determine whether a merchant transaction does, in fact, affect the available balance, even where the merchant transaction involves an over-authorizing merchant. Thus, in addition to, or instead of, making broad generalizations as to which transactions affect the available balance, the apparatus can be configured to make individual, transaction-by-transaction determinations as to which transactions actually do affect the available balance.

Regarding blocks 150 and 160, the phrase “online banking account,” as used herein, generally refers to an account that is accessible to an account holder via a network (e.g., the Internet, and the like) and that includes information associated with a deposit account. It will be understood that the online banking account include one or more online banking accounts, mobile banking accounts, SMS banking accounts, and/or the like. In some embodiments, the account holder can use the online banking account to check their available balance, view transactions, pay bills, transfer funds, order checks, and/or perform one or more other tasks involving the deposit account. In some embodiments, the online banking account is embodied as and/or includes one or more web pages, HTML pages, Internet pages, intranet pages, dashboard application pages, and/or the like. In some embodiments, the online banking account is accessible using a personal computer, mobile phone, ATM, gaming device, and/or the like. In some embodiments, the online banking account holder is identified and/or authenticated before being provided access to his or her online banking account. For example, in some embodiments, the account holder is required to present and/or provide (e.g., via a login page, and the like) one or more usernames/passwords, personal identification numbers (“PINs”), biometric information, secret information, answers to challenge questions, and/or one or more other credentials to the financial institution that maintains the online banking account, so that the financial institution can verify that the account holder is who he says he is prior to the financial institution allowing the account holder to access the online banking account.

In some embodiments, the online banking account is provided, serviced, operated, controlled, managed, and/or maintained (collectively referred to herein as “maintained” for simplicity) by the same financial institution that maintains the deposit account and/or the apparatus configured to perform the process flow 100. For example, in some embodiments, the apparatus is maintained by a bank, the deposit account is held by an account holder and maintained by the bank, and the online banking account is accessible to the account holder and maintained by the bank. Of course, in some embodiments, the apparatus, the deposit account, and/or the online banking account are not maintained by the same financial institution or any financial institution.

Further regarding blocks 150 and 160, the first and/or second information posted to the online banking account can include any type and/or amount of information. In some embodiments, the first information includes some or all of the first transaction information received by the apparatus configured to perform the process flow 100. Additionally or alternatively, in some embodiments, the second information includes some or all of the second transaction information received by the apparatus. However, in other embodiments, the first and/or second information does not include any of the first and/or second transaction information.

Also, it will be understood that the apparatus configured to perform the process flow 100 can be configured to post the first and second information to the online banking account in any way. For example, in some embodiments, the apparatus is configured to post the first information by: (a) posting a description of the first transaction to a first portion of the online banking account; and (b) posting information to the online banking account that indicates that the available balance is based at least partially on transactions described in the first portion. Additionally or alternatively, in some embodiments, the apparatus is configured to post the second information by: (a) posting a description of the second transaction to a second portion of the online banking account; and (b) posting information to the online banking account that indicates that the available balance is not based on transactions described in the second portion. In some embodiments, the first information includes the description of the first transaction (or vice versa), and the second information includes the description of the second transaction (or vice versa). In some embodiments, the first portion of the online banking account is embodied as and/or includes a first portion of a transaction ledger in the online banking account, and the second portion of the online banking account is embodied as and/or includes a second portion of the transaction ledger. In some embodiments, the transaction ledger separates the transactions into two, easy-to-understand portions so that, for example, the account holder can quickly and easily determine which transactions affect the available balance and which do not.

In some embodiments, the apparatus is configured to post the first information by: (a) posting a first transaction amount associated with the first transaction to the online banking account; and (b) posting information proximate to (e.g., near, within, inside, adjacent, next to, and the like) the first transaction amount, where the information indicates that the first transaction amount is included in the available balance. Additionally or alternatively, in some embodiments, the apparatus is configured to post the second information by: (a) posting a second transaction amount associated with the second transaction to the online banking account; and (b) posting information proximate to the second transaction amount that indicates that the second transaction amount is not included in the available balance. In some embodiments, the first information includes the first transaction amount (or vice versa), and the second information includes the second transaction amount (or vice versa).

Additionally or alternatively, in some embodiments, the apparatus configured to perform the process flow 100 is configured to post the first information by: (a) posting a transaction amount associated with the first transaction to a first portion of a transaction ledger in the online banking account; and (b) posting information that indicates that transaction amounts posted to the first portion of the transaction ledger are included in the available balance. In some embodiments, the apparatus is additionally or alternatively configured to post the second information by: (a) posting a transaction amount associated with the second transaction to a second portion of the transaction ledger in the online banking account; and (b) posting information that indicates that transaction amounts posted to the second portion of the transaction ledger are not included in the available balance.

In some embodiments, the apparatus configured to perform the process flow 100 can be configured to perform any one or more portions of the process flow 100 represented by blocks 110-160 upon or after one or more triggering events, which, in some embodiments, is one or more of the other portions of the process flow 100. As used herein, it will be understood that a “triggering event” refers to an event that automatically triggers the execution, performance, and/or implementation of a triggered action, either immediately, nearly immediately (i.e., within minutes), or sometime after the occurrence of the triggering event. For example, in some embodiments, the apparatus is configured such that the apparatus receiving the first transaction information (the triggering event) automatically and immediately triggers the apparatus to determine, based at least partially on the first transaction information, whether the available balance associated with the deposit account is based at least partially on the first transaction (the triggered action). In some embodiments, the apparatus is additionally or alternatively configured to automatically post the first information to the online banking account (triggered action) simultaneous with or sometime after (e.g., minutes after, four hours after, two days after, and the like) determining that the available balance is based at least partially on the first transaction (triggering event).

In some embodiments, a predetermined time and/or the passage of a predetermined period of time may serve to trigger one or more of the portions represented by blocks 110-160. Also, in some embodiments, the apparatus is configured to automatically perform one or more (or all) of the portions of the process flow 100 represented by blocks 110-160. In other embodiments, one or more (or all) of the portions of the process flow 100 represented by blocks 110-160 require and/or involve human intervention. Additionally or alternatively, in some embodiments, one or more (or all) of the portions of the process flow 100 are performed by one or more persons by using, or without using, the apparatus configured to perform the process flow 100. For example, in some embodiments, the process flow 100 represents the process flow of a “pure” business method that is performed, for example, by one or more employees associated with a financial institution that maintains the deposit account referred to in the process flow 100. In addition to the process flow 100, any of the embodiments described and/or contemplated herein can involve one or more triggering events, triggered actions, automatic actions, apparatus actions, and/or human actions.

In addition, in some embodiments, the apparatus configured to perform the process flow 100 (and/or a user thereof) is configured to perform one or more (or all) of the portions of the process flow 100, individually or collectively, within moments, seconds, and/or minutes (e.g., within approximately 1-15 minutes, and the like). In some embodiments, the apparatus is configured to perform one or more portions of the process flow 100 in real time, in substantially real time, and/or at one or more predetermined times. Further, the number, order, and/or content of the portions of the process flow 100 are exemplary and may vary. Also, one or more of the portions of the process flow 100 can occur at any time with respect to the status of the first and/or second transaction. For example, in some embodiments, the apparatus is configured to perform one or more portions of the process flow 100 after the first and/or second transactions are initiated, after the first and/or second transactions are authorized, after the first and/or second transactions are finalized, and/or the like.

Of course, the process flow 100, like all of the other process flows described herein, can include one or more additional and/or alternative process flow portions, and the apparatus configured to perform the process flow 100 can be configured to perform one or more additional and/or alternative functions. For example, in some embodiments, the process flow 100 includes determining the available balance associated with the deposit account and/or posting the available balance to the online banking account. Also, the apparatus can be configured to perform any one or more portions of any one or more embodiments described and/or contemplated herein, including, for example, any one or more portions of the process flows 200, 300, 400, and/or 500 described later herein.

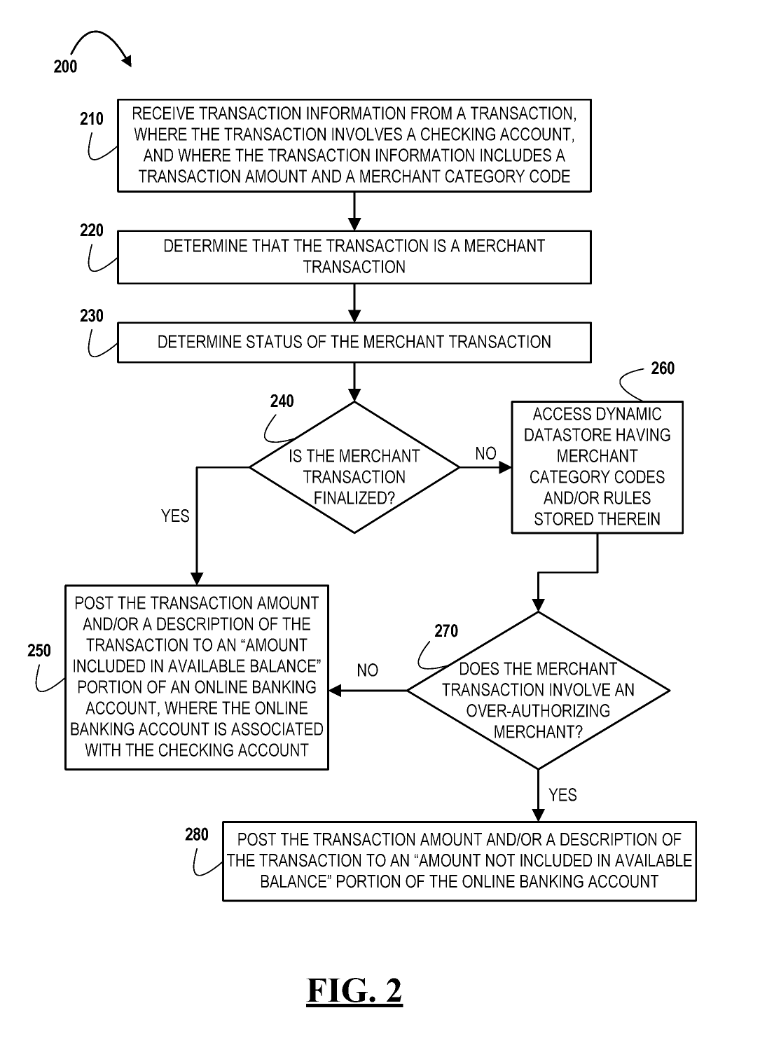

Referring now to FIG. 2, a general process flow 200 for posting available balance information to an online banking account is provided, where the available balance information is associated with a merchant transaction, in accordance with an embodiment of the present invention. In some embodiments, the process flow 200 is performed by an apparatus having hardware and/or software configured to perform one or more portions of the process flow 200. In such embodiments, as represented by block 210, the apparatus is configured to receive transaction information from a transaction, where the transaction involves a checking account, and where the transaction information includes a transaction amount and a merchant category code. The merchant category code is associated with a merchant involved in the transaction. As represented by block 220, after receiving the transaction information, the apparatus is configured to determine that the transaction is a merchant transaction, which, in some embodiments, is based at least partially on the presence of the merchant category code in the transaction information.

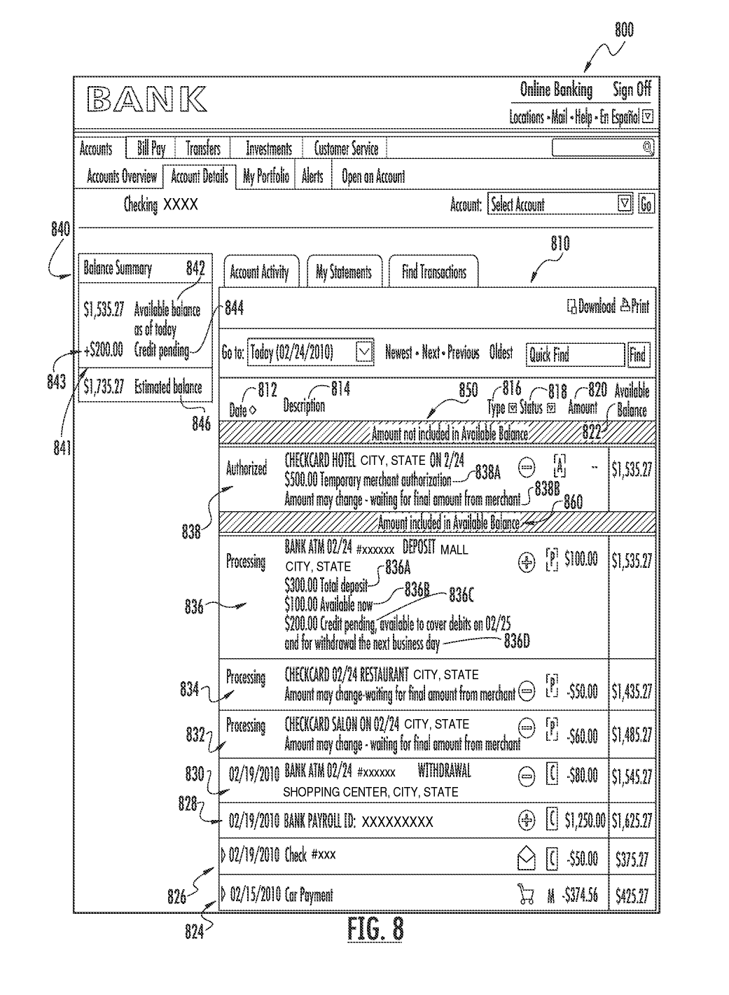

Thereafter, the apparatus is configured to determine the status of the merchant transaction, as represented by block 230. For example, the apparatus may determine that the merchant transaction is initiated but not authorized, authorized but not finalized, finalized, or the like. In some embodiments, the apparatus is configured to make this determination based at least partially on identifying the status of the transaction from the transaction information. After determining the transaction status, the apparatus is configured to determine whether the merchant transaction is finalized, as represented by block 240. If it is, then the apparatus is configured to post the transaction amount and/or a description of the transaction to an “Amount included in Available Balance” portion of an online banking account (e.g., the Amount included in Available Balance portion 860 of the transaction ledger 810 shown in FIG. 8), where the online banking account is associated with the checking account. In some embodiments, the Amount included in Available Balance portion is meant to indicate that the available balance for the checking account is based at least partially on the transactions described in the Amount included in Available Balance portion. Additionally or alternatively, in some embodiments, the transaction amounts posted to the Amount included in Available Balance portion are included in the available balance and are immediately available.

However, if the apparatus determines that the merchant transaction is not finalized, then the apparatus is configured to access a dynamic datastore having merchant category codes and/or rules stored therein, as represented by block 260. The apparatus then determines, based at least partially on the information in the datastore, whether the merchant transaction involves an over-authorizing merchant, as represented by block 270. For example, in some embodiments, the apparatus is configured to compare the merchant category code from the transaction information to a list of merchant category codes that are stored in the datastore and are associated with over-authorizing merchants. If the merchant category code from the transaction information is on the list, then the apparatus is configured to determine that the transaction involves an over-authorizing merchant. On the other hand, if the merchant category code from the transaction information is not on the list, then the apparatus is configured to determine that the transaction does not involve an over-authorizing merchant.

As shown in FIG. 2, the apparatus is configured to post the transaction amount and/or the description of the transaction to the Amount included in Available Balance portion of the online banking account, as represented by block 250, if the apparatus determines that the transaction does not involve an over-authorizing merchant. However, if the apparatus determines that the merchant transaction does involve an over-authorizing merchant, then the apparatus is configured to post the transaction amount and/or the description of the transaction to an “Amount not included in Available Balance” portion of the online banking account (e.g., the Amount not included in Available Balance portion 850 of the transaction ledger 810 shown in FIG. 8), as represented by block 280. In some embodiments, the Amount not included in Available Balance portion is meant to indicate that the available balance is not based on the transactions described therein. Additionally or alternatively, in some embodiments, the transaction amounts posted to the Amount not included in Available Balance portion are not included in the available balance and are not immediately available.

Of course, the embodiment illustrated in FIG. 2 is merely exemplary and other embodiments may vary without departing from the scope and spirit of the present invention. For example, in some alternative embodiments, the apparatus is configured to determine whether the merchant transaction involves an over-authorizing merchant before or simultaneous with determining whether the merchant transaction is finalized. Also, the apparatus configured to perform the process flow 200 can be configured to perform one or more portions of the process flow 200 in real time, in substantially real time, and/or at one or more predetermined times. The apparatus configured to perform the process flow 200 may be configured to perform any of the portions of the process flow 200 represented by blocks 210-280 upon or after one or more triggering events, which, in some embodiments, is the performance of one or more of the other portions of the process flow 200. In addition, in some embodiments, the apparatus configured to perform the process flow 200 (and/or a user thereof) is configured to perform each portion of the process flow 200, from start to finish, within moments, seconds, and/or minutes (e.g., within approximately 1-15 minutes, and the like).

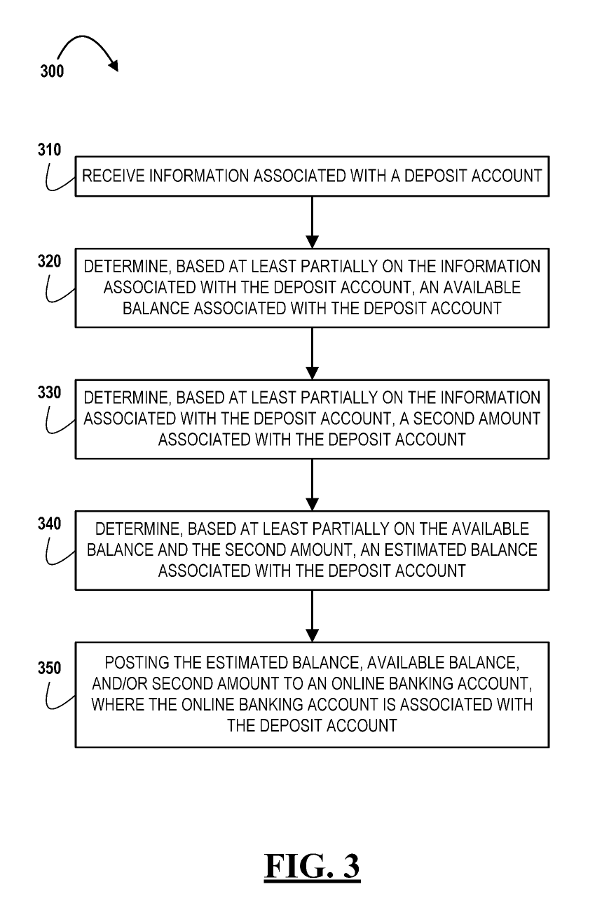

Referring now to FIG. 3, a general process flow 300 for posting estimated balance information to an online banking account is provided, in accordance with an embodiment of the present invention. In some embodiments, the process flow 300 is performed by an apparatus having hardware and/or software configured to perform one or more portions of the process flow 300. In such embodiments, as represented by block 310, the apparatus is configured to receive information associated with a deposit account. As represented by block 320, the apparatus is configured to determine, based at least partially on the information associated with the deposit account, an available balance associated with the deposit account. As represented by block 330, the apparatus is configured to determine, based at least partially on the information associated with the deposit account, a second amount associated with the deposit account. In addition, as represented by block 340, the apparatus is configured to determine, based at least partially on the available balance and the second amount, an estimated balance associated with the deposit account. As represented by block 350, the apparatus is configured to post the estimated balance, available balance, and/or second amount to an online banking account, where the online banking account is associated with the deposit account.

For simplicity, the information associated with the deposit account is sometimes referred to herein as “deposit account information.” Also for simplicity, the portion of the process flow 300 represented by block 320 is sometimes referred to herein as the “available balance determination,” the portion represented by block 330 is sometimes referred to herein as the “second amount determination,” and the portion represented by block 340 is sometimes referred to herein as the “estimated balance determination.”

Regarding block 310, the apparatus can be configured to receive the deposit account information in any way. In addition, the deposit account information can include any amount and/or type of information, including any of the transaction information discussed previously in connection with the process flow 100. The deposit account information can be received from the source of the transaction and/or from one or more datastores having transaction information stored therein.

Regarding block 320, the apparatus can be configured to make the available balance determination in any way. For example, in some embodiments, another apparatus is configured to make the available balance determination and then communicate that determination to the apparatus configured to perform the process flow 300. In other embodiments, the apparatus configured to perform the process flow 300 is configured to make the available balance determination itself based at least partially on, for example, one or more transaction amounts associated with one or more transactions involving the deposit account. In some embodiments, the apparatus is configured to sum all of the transaction amounts included in the available balance in order to determine the available balance. In some embodiments, the apparatus is configured to make the available balance determination based at least partially on one or more merchant category codes associated with one or more transactions involving the deposit account. In some embodiments, the apparatus is configured to make the available balance determination based at least partially on determining the total amount of funds immediately available to the account holder, for withdrawal, to cover debit transactions, in the deposit account, and/or the like.

Regarding block 330, the apparatus can be configured to make the second amount determination in any way. As used herein, the phrase “second amount” generally refers to one or more transaction amounts associated with one or more transactions, where the one or more transactions involve the deposit account, and where the one or more transaction amounts are not immediately available and/or are not included in the available balance. In some embodiments, the apparatus is configured to make the second amount determination based at least partially on one or more transactions involving the deposit account, where the one or more transactions are subject to a hold. For example, in some embodiments, the second amount includes any transaction amount from a transaction that is subject to a hold. It will be understood that when a transaction is said to be “subject to a hold,” the entire transaction amount and/or the entire transaction is subject to the hold, or a transaction amount less than the entire transaction amount is subject to the hold.

A hold may be classified as a “soft” hold and/or a “hard” hold based at least partially on one or more rules that are, for example, set by a financial institution. For example, a soft hold may result where the deposit account is less than 5 days old, where the deposit account has received 9 or more deposits in the last 48 hours, where a total deposit amount is very large and/or exceeds some predetermined deposit maximum set by a financial institution, and/or the like. In such cases, the transaction may be subject to a hold so that, for example, the financial institution can scrutinize the transaction in more detail. As an example, in some embodiments, where the transaction involves a check deposit transaction, and where the check amount is very large (e.g., greater than $10,000), the check amount may not be made immediately available upon deposit because, for example, the financial institution receiving the check may want to inspect the actual check and/or any information in the check first. As another example, in some embodiments, a soft hold may be placed on every check deposit transaction received by a financial institution as a matter of policy.

A hard hold may result where, for example, the deposit account is dormant/inactive, where an account holder associated with the deposit account has recently died, where the deposit account and/or the deposit transaction is suspected of involving misappropriation and/or some other illegality, and/or the like. For example, in some embodiments, where the transaction involves a wire transfer to an account that is associated with a person who has the same name as a person known to be involved in misappropriations, the transaction may be subject to a hard hold until, for example, a financial institution verifies the identity of the receiving account. In some embodiments, where a transaction is subject to a soft hold and/or a hard hold, a transaction amount associated with that transaction is sometimes referred to herein as “an amount delayed.” Thus, in accordance with some embodiments, the second amount can be the total amount delayed associated with the deposit account.

Further regarding block 330, the apparatus can be configured to make the second amount determination based at least partially on one or more transactions involving the deposit account, where those one or more transactions are authorized but not finalized. Specifically, in some embodiments, the second amount includes any transaction amount from a transaction that has been authorized but not finalized. For example, in some embodiments, the second amount includes an authorized but not finalized transaction amount from a purchase transaction involving an over-authorizing merchant. Thus, in some embodiments, the second amount can be the total authorized but not finalized amount associated with a deposit account. Also, the second amount can be a negative amount or a positive amount. In some embodiments, the second amount includes any transaction amount associated with a transaction, where the transaction is associated with one or more particular merchant category codes.

In some embodiments of the invention, the second amount includes any transaction amount associated with a transaction that is not subject to a hold but is, for one or more other reasons, not immediately available. In some embodiments, where a transaction involves a deposit into the deposit account, and where all or a portion of the total deposit amount associated with that transaction is pending, not subject to a hold, and not immediately available, that pending transaction amount is sometimes referred to herein as “credit pending.” Thus, in accordance with some embodiments, the second amount can be the total credit pending amount associated with the deposit account.

Regarding block 340, the apparatus can be configured to make the estimated balance determination in any way. In some embodiments, the apparatus is configured to determine the estimated balance by adding the available balance and the second amount. In other words, in some embodiments, the estimated balance is the sum of the available balance and the second amount. For example, in some embodiments, where the apparatus has determined that the available balance is $1,100, the credit pending amount is $500, and the total amount delayed is $200, the apparatus can be configured to determine that the estimated balance equals $1,800 (i.e., $1,100+$500+$200=$1,800). In some embodiments, the estimated balance is the amount that is estimated to be in the deposit account once all transactions involving the deposit account have finalized and/or cleared. In some embodiments, the estimated balance is an estimate and not a promise that the deposit account will actually have the estimated balance on a specified date. In some embodiments, the estimated balance provides the account holder with an indication of what his or her available balance will be in the future.

Regarding block 350, the apparatus can be configured to post the estimated balance, available balance, and/or second amount to the online banking account in any way. For example, in some embodiments, the apparatus is configured to post one or more (or all) of these amounts to a balance summary portion in the online banking account. As such, in some embodiments, the account holder may access the online banking account and quickly identify the available balance and the estimated balance associated with the deposit account, as well as any credit pending and/or total delayed amounts associated with the deposit account. In some embodiments, the apparatus is additionally configured to post information to the online banking account that indicates that the estimated balance is based at least partially on the available balance and the second amount. For example, in some embodiments, the apparatus is configured to post the estimated balance, the available balance, and the second amount to a balance summary portion in the online banking account, as well as to post information that indicates that the estimated balance is the sum of the available balance and the second amount.

Of course, the embodiment illustrated in FIG. 3 is merely exemplary and other embodiments may vary without departing from the scope and spirit of the present invention. In addition, the apparatus configured to perform the process flow 300 can be configured to perform one or more portions of the process flow 300 in real time, in substantially real time, and/or at one or more predetermined times. The apparatus may be configured to perform any of the portions of the process flow 300 represented by blocks 310-350 upon or after one or more triggering events, which, in some embodiments, is the performance of one or more of the other portions of the process flow 300. In addition, in some embodiments, the apparatus (and/or a user thereof) is configured to perform each portion of the process flow 300, from start to finish, within moments, seconds, and/or minutes (e.g., within approximately 1-15 minutes, and the like).

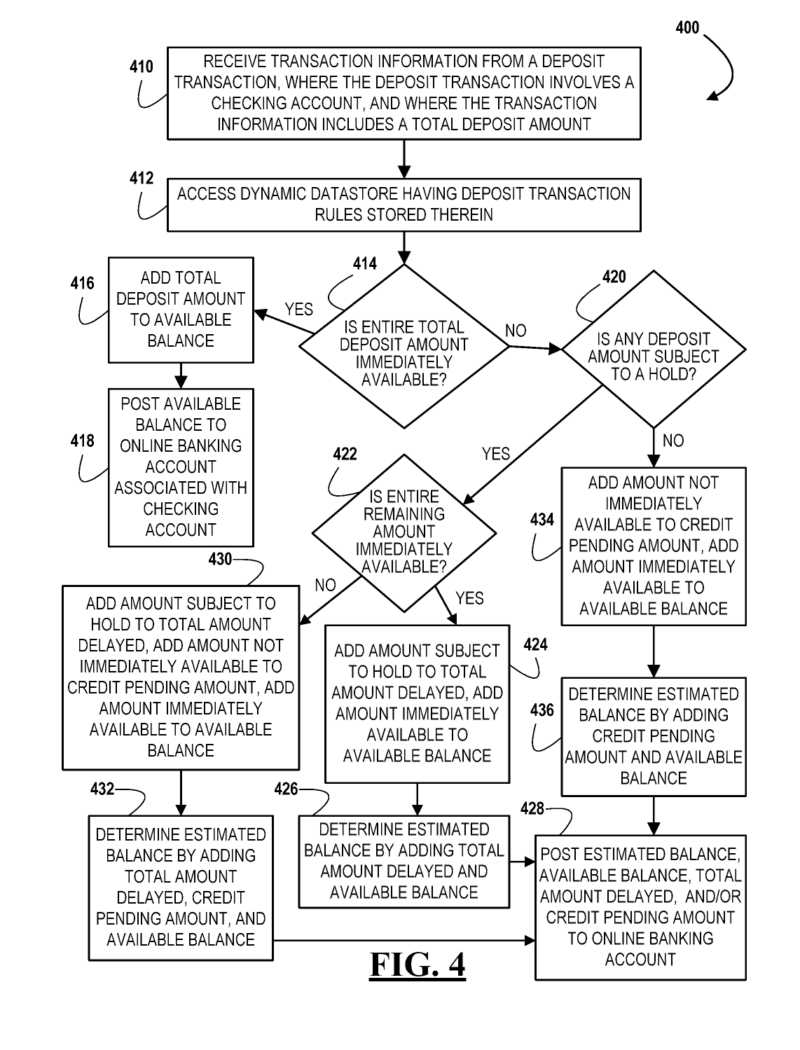

Referring now to FIG. 4, a general process flow 400 for posting available balance and/or estimated balance information to an online banking account is provided, where the available balance and/or estimated balance information is associated with a deposit transaction, in accordance with an embodiment of the present invention. In some embodiments, the process flow 400 is performed by an apparatus having hardware and/or software configured to perform one or more portions of the process flow 400. In such embodiments, as represented by block 410, the apparatus is configured to receive transaction information from a deposit transaction, where the deposit transaction involves a checking account, and where the transaction information includes a total deposit amount. As represented by block 412, the apparatus is configured to access a dynamic datastore having one or more deposit transaction rules and/or other information stored therein. Then, as represented by block 414, the apparatus is configured to determine whether the entire total deposit amount is immediately available. For example, in some embodiments, the apparatus is configured to compare the total deposit amount from the transaction information to a predetermined deposit maximum stored in the datastore, where the deposit maximum is associated with, and/or unique to, the checking account. If the total deposit amount is greater than the deposit maximum for the checking account, then the apparatus is configured to determine that the entire total deposit amount is not immediately available. However, if the total deposit amount is less than or equal to the deposit maximum for the checking account, then the apparatus is configured to determine that the entire total deposit amount is immediately available.

If the apparatus determines that the entire total deposit amount is immediately available, then the apparatus is configured to add the total deposit amount to the available balance associated with the checking account, as represented by block 416. For example, if the existing available balance for the checking account is $500, the total deposit amount is $75, and the entire total deposit amount is immediately available, then the apparatus is configured to determine that the available balance is $575 after processing the deposit transaction. After determining the available balance, the apparatus is further configured to post the available balance to an online banking account associated with the checking account, as represented by block 418. In some embodiments, the apparatus is configured to post the available balance to a balance summary portion of the online banking account (e.g., the balance summary portion 840 shown in FIG. 8).

If the apparatus determines that the entire total deposit amount is not immediately available, then the apparatus is configured to determine whether any deposit amount from the total deposit amount is subject to a hold, as represented by block 420. In some embodiments, the apparatus determines that the a deposit amount is subject to a hold based at least partially on comparing the transaction information from the deposit transaction to information stored in the dynamic datastore referred to in block 412. For example, in some embodiments, where the dynamic datastore stores information relating to the ages of checking accounts, the apparatus can be configured to determine that at least part of the total deposit amount is subject to a hold because the checking account into which the deposit transaction is being made has been open for only three days. If, however, the checking account has been open for four years, then the apparatus may be configured to determine that none of the total deposit amount is subject to a hold.

If the apparatus determines that any deposit amount is subject to a hold, then the apparatus is configured to determine whether the entire remaining amount is immediately available, as represented by block 422. In other words, if the total deposit amount is $1,400 and $300 of that amount is subject to a hold, then the apparatus is configured to determine whether the entire remaining $1,100 is immediately available. If so, then the apparatus is configured to add the deposit amount subject to the hold to a total amount delayed for the checking account, and add the amount immediately available (i.e., the entire remaining amount) to the available balance for the checking account, as represented by block 424. Thereafter, the apparatus is configured to determine the estimated balance for the checking account by adding the total amount delayed and the available balance, as represented by block 426. Then, as represented by block 428, the apparatus is configured to post the estimated balance, the available balance, and/or the total amount delayed to the online banking account. In some embodiments, the apparatus is configured to post the estimated balance, available balance, and/or total amount delayed to a balance summary portion of the online banking account (e.g., the balance summary portion 840 shown in FIG. 8).

If the apparatus determines that the entire total deposit amount is not immediately available, that some of the total deposit amount is subject to a hold, and that the entire remaining amount is not immediately available, then the apparatus is configured to add the amount subject to the hold to the total amount delayed, add the amount not immediately available to a credit pending amount for the checking account, and add the amount immediately available (if any) to the available balance, as represented by block 430. Thereafter, the apparatus is configured to determine the estimated balance by adding the total amount delayed, the credit pending amount, and the available balance, as represented by block 432. As represented by block 428, the apparatus is further configured to post the estimated balance, available balance, total amount delayed, and/or credit pending amount to the online banking account. In some embodiments, the apparatus is configured to post one or more (or all) of these amounts to a balance summary portion of the online banking account (e.g., the balance summary portion 840 shown in FIG. 8).

As shown in FIG. 4, if the apparatus determines that the entire total deposit amount is not immediately available and that none of the total deposit amount is subject to a hold, then the apparatus is configured to add the amount not immediately available to a credit pending amount for the checking account, and add the amount immediately available (if any) to the available balance, as represented by block 434. Thereafter, the apparatus is configured to determine the estimated balance for the checking account by adding the credit pending amount and the available balance, as represented by block 436. Then, as represented by block 428, the apparatus is configured to post the estimated balance, available balance, and credit pending amount to the online banking account. In some embodiments, the apparatus is configured to post one or more (or all) of these amounts to a balance summary portion of the online banking account (e.g., the balance summary portion 840 shown in FIG. 8).

Of course, the embodiment illustrated in FIG. 4 is merely exemplary and other embodiments may vary without departing from the scope and spirit of the present invention. For example, in some embodiments, the apparatus is configured to determine whether any amount from the total deposit amount is subject to a hold before determining whether the entire total deposit amount is immediately available. In addition, the apparatus configured to perform the process flow 400 can be configured to perform one or more portions of the process flow 400 in real time, in substantially real time, and/or at one or more predetermined times. Also, the apparatus may be configured to perform any of the portions of the process flow 400 represented by blocks 410-436 upon or after one or more triggering events, which, in some embodiments, is the performance of one or more of the other portions of the process flow 400. In addition, in some embodiments, the apparatus (and/or a user thereof) is configured to perform each portion of the process flow 400, from start to finish, within moments, seconds, and/or minutes (e.g., within approximately 1-15 minutes, and the like).

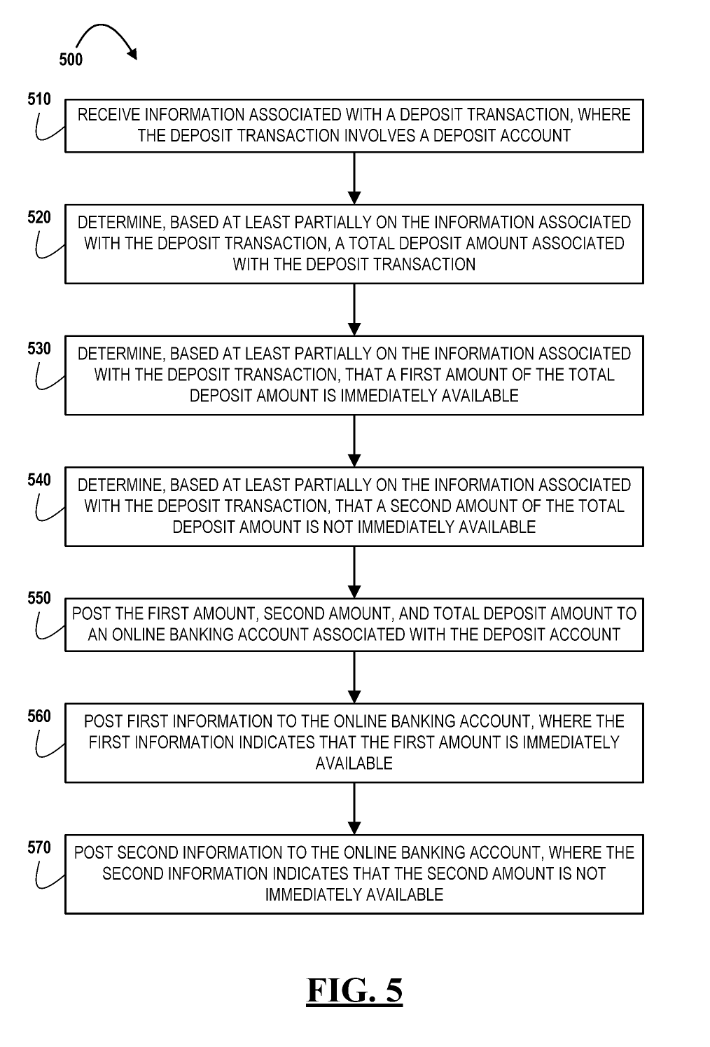

Referring now to FIG. 5, a general process flow 500 for posting deposit transaction-level information to an online banking account is provided, in accordance with an embodiment of the present invention. In some embodiments, the process flow 500 is performed by an apparatus having hardware and/or software configured to perform one or more portions of the process flow 500. In such embodiments, as represented by block 510, the apparatus is configured to receive information associated with a deposit transaction, where the deposit transaction involves a deposit account. As represented by block 520, the apparatus is configured to determine, based at least partially on the information associated with the deposit transaction, a total deposit amount associated with the deposit transaction. As represented by block 530, the apparatus is further configured to determine, based at least partially on the information associated with the deposit transaction, that a first amount of the total deposit amount is immediately available. In addition, as represented by block 540, the apparatus is configured to determine, based at least partially on the information associated with the deposit transaction, that a second amount of the total deposit amount is not immediately available. As represented by block 550, the apparatus is configured to post the first amount, second amount, and total deposit amount to an online banking account associated with the deposit account. As represented by block 560, the apparatus is also configured to post first information to the online banking account, where the first information indicates that the first amount is immediately available. As represented by block 570, the apparatus is further configured to post second information to the online banking account, where the second information indicates that the second amount is not immediately available.

For simplicity, information associated with the deposit transaction is sometimes referred to herein as “deposit transaction information.” Also for simplicity, the portion of the process flow 500 represented by block 520 is sometimes referred to herein as the “total deposit amount determination,” the portion represented by block 530 is sometimes referred to herein as the “first amount determination,” and the portion represented by block 540 is sometimes referred to herein as the “second amount determination.” To avoid confusion, the “second amount” referred to in connection with FIG. 5 is not necessarily the same “second amount” referred to in connection with FIG. 3.

Regarding block 510, the apparatus can be configured to receive the deposit transaction information in any way. Also, the deposit transaction information can include any amount and/or type of information, including the information discussed previously in connection with the process flow 100. For example, in some embodiments, deposit transaction information includes any information that identifies, defines, describes, and/or is otherwise associated with one or more deposit transactions. As used herein, the phrase “deposit transaction,” generally refers to one or more transactions in which one or more checks, cash, and/or funds are deposited into a deposit account. As with other transaction information, exemplary deposit transaction information includes, but is not limited to, the type of the transaction (e.g., a deposit transaction, ATM transaction, teller transaction, and the like), the status of the transaction (e.g., delayed, held, finalized, and the like), the party(ies) involved in the transaction, the date and/or time of the transaction, the posting date of the transaction, the account(s) involved in the transaction, the transaction amount(s) associated with the transaction (e.g., the total deposit amount of the deposit transaction, the good(s) and/or service(s) involved in the transaction, a description of the transaction, and/or the like. In some embodiments, the deposit transaction information additionally or alternatively includes information indicating that the first amount of the total deposit amount is included in the available balance and/or that the second amount of the total deposit amount is not included in the available balance. Additionally or alternatively, the apparatus can be configured to receive the deposit transaction information from the source of the transaction.

Regarding blocks 520-540, the apparatus can be configured to make the total deposit amount determination, first amount determination, and second amount determination in any way, including in one or more of the ways previously described and/or contemplated herein. For example, in some embodiments, the apparatus is configured to make the first amount determination based at least partially on determining that the first amount is a cash deposit amount. As another example, in some embodiments, the apparatus is configured to make the second determination based at least partially on determining that the second amount is subject to a hold. In some embodiments, the first amount of the total deposit amount equals the total deposit amount, or the second amount of the total deposit amount equals the total deposit amount. In other words, in accordance with some embodiments, the apparatus may determine that the entire total deposit amount associated with the deposit transaction is immediately available (i.e., the second amount is $0) or that none of the total deposit amount is immediately available (i.e., the first amount is $0).

Regarding blocks 550-570, the apparatus can be configured to post the first amount, second amount, total deposit amount, first information, and the second information to the online banking account in any way, including in one or more of the ways previous described and/or contemplated herein. For example, in some embodiments, the apparatus is configured to post: (a) the first amount to a transaction ledger in the online banking account; and (b) the first information proximate to the first amount. The apparatus can also post the second amount and second information in the same way, that is, by posting: (a) the second amount to a transaction ledger in the online banking account; and (b) the second information proximate to the second amount. In some embodiments, the apparatus is configured to post the total deposit amount, the first amount, the second amount, the first information, and the second information, all to a single transaction ledger entry of a transaction ledger in the online banking account. In some embodiments, because the total deposit amount, the first amount, the second amount, the first information, and/or the second information are posted to the online banking account, the online banking account is said to include “deposit transaction-level” information. In some embodiments, where the online banking account includes deposit transaction-level information, the account holder is able to determine exactly how the total deposit amount is broken down into an immediately available amount and a not immediately available amount.

Of course, the embodiment illustrated in FIG. 5 is merely exemplary and other embodiments may vary without departing from the scope and spirit of the present invention. For example, in some embodiments, the apparatus configured to perform the process flow 500 is additionally or alternatively configured to: (a) determine when the second amount will be immediately available; and (b) post third information to the online banking account, where the third information indicates when the second amount will be immediately available. As an example, in some embodiments, the apparatus is configured to determine that: (a) a total deposit amount of $500 was made into a savings account on 4/15; (b) a $200 amount of that total deposit amount is not immediately available on 4/15; (c) the $200 amount will be immediately available on 4/18; and (d) post information to an online banking account associated with the savings account, where the information indicates that the $200 amount of the $500 total deposit amount will be available on 4/18.

As another example of an additional or alternative portion, in some embodiments, the apparatus is configured to post a description of the deposit transaction to the online banking account, such that the description is posted proximate to the total deposit amount, first amount, second amount, first information, and/or second information. In some embodiments, the description includes the total deposit amount, first amount, second amount, first information, and/or second information (or vice versa). For example, in some embodiments, where the deposit transaction occurred at an ATM, the apparatus is configured to post a description of the deposit transaction to the online banking account, where the description: (a) includes the total deposit amount, first amount, second amount, first information, and second information; (b) identifies the status and type of the deposit transaction (e.g., pending transaction, ATM transaction, deposit transaction, and the like); (c) identifies the ATM involved in the deposit transaction, the location of the ATM, and the date of the deposit transaction; and (d) indicates when the second amount will be made immediately available.

In some embodiments, the apparatus is additionally or alternatively configured to post a description of the deposit transaction to a transaction ledger in the online banking account, such that a single entry in the transaction ledger includes the first amount, second amount, total deposit amount, first information, second information, and the description. (In some embodiments, the description itself may include the first amount, second amount, total deposit amount, first information, and/or second information therein.) In some embodiments, the apparatus is configured to: (a) post a description of the deposit transaction to the online banking account; and (b) post the first information by posting, proximate to the description, a path (e.g., link, button, drop-down menu, and the like) to view the first information. In other embodiments, the apparatus is configured to: (a) post a description of the deposit transaction to the online banking account; and (b) post the first information and/or the second information by configuring the description as a path to view the first information and/or the second information. For example, in some embodiments, the description of the transaction appears as a selectable link in the online banking account, such that selecting the description (e.g., with a mouse cursor) causes the first information and/or the second information to be displayed in the online banking account.

In addition, the apparatus can be configured to perform one or more portions of the process flow 500 in real time, in substantially real time, and/or at one or more predetermined times. Also, the apparatus may be configured to perform any of the portions of the process flow 500 represented by blocks 510-570 upon or after one or more triggering events, which, in some embodiments, is the performance of one or more of the other portions of the process flow 500. In addition, in some embodiments, the apparatus (and/or a user thereof) is configured to perform each portion of the process flow 500, from start to finish, within moments, seconds, and/or minutes (e.g., within approximately 1-15 minutes, and the like).

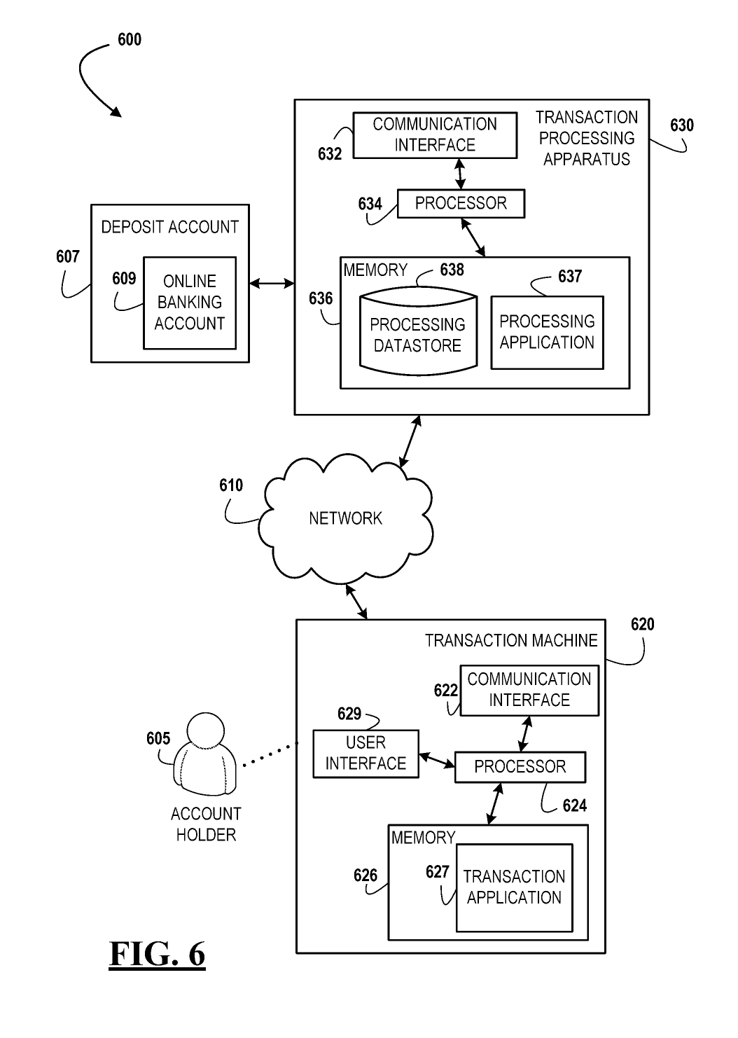

Referring now to FIG. 6, a system 600 for posting available balance information, estimated balance information, and/or deposit transaction-level information to an online banking account is provided, in accordance with an embodiment of the present invention. As illustrated, the exemplary system 600 includes a network 610, a transaction machine 620, and a transaction processing apparatus 630. Also shown are a deposit account 607, an online banking account 609 associated with the deposit account 607, and an account holder 605 that holds the deposit account 607. In this example embodiment, the account holder 405 has access to the transaction machine 620, deposit account 607, and online banking account 609. In addition, the deposit account 607, online banking account 609, and transaction processing apparatus 630 are each maintained by a single financial institution (not shown), and the account holder 605 is a customer of that financial institution.

As shown in FIG. 6, the transaction machine 620 and the transaction processing apparatus 630 are each operatively connected to the network 610, which may include one or more separate networks. In addition, the network 610 may include one or more interbank networks, telephone networks, telecommunication networks, local area networks (LANs), wide area networks (WANs), and/or global area networks (GANs) (e.g., the Internet, and the like). The network 610 may be secure and/or unsecure and may also include wireless and/or wireline technology.

The transaction machine 620 may include any computerized apparatus that can be configured to perform any one or more of the functions of the transaction machine 620 described and/or contemplated herein. It will also be understood that the transaction machine 620 can include and/or be embodied as any transaction machine described and/or contemplated herein. It will further be understood that the transaction machine 620 can initiate, perform, complete, and/or otherwise facilitate any transaction described and/or contemplated herein as being initiated, performed, and/or otherwise facilitated by a transaction machine. In some embodiments, the transaction machine 620 includes and/or is embodied as an interactive computer terminal configured to initiate, perform, complete, and/or facilitate any number and/or type of transaction, including those discussed above in connection with the process flow 100. For example, in some embodiments, the transaction machine 620 includes and/or is embodied as a POS device, ATM, self-checkout machine (e.g., at a grocery store, retail store, and the like), vending machine, kiosk, computer (e.g., personal computer, laptop computer, workstation computer, tablet computer, and the like), mobile phone (e.g., smart phone, feature phone, and the like), network-connected media device, personal digital assistant (PDA), gaming device, network device, front end system, back end system, and/or the like.

In some embodiments of the invention, the transaction machine 620 is located in a public place and is available for public use (e.g., on a street corner, on the exterior wall of a banking center, and the like). In other embodiments, the transaction machine 620 is additionally or alternatively located in a place of business and available for public and/or business customer use (e.g., in a post office, in a banking center, and the like). In some embodiments, the transaction machine 620 is not owned by the user of the transaction machine. However, in other embodiments, the transaction machine 620 is located in a private place, is available for private use, and/or is owned, possessed, and/or carried by the user of the transaction machine 620.

In some embodiments of the invention, the transaction machine 620 (and/or one or more other portions of the system 600) requires its users to authenticate themselves to the transaction machine 620 before the transaction machine 620 (and/or one or more other portions of the system 600) will initiate, perform, complete, and/or facilitate a transaction. For example, in some embodiments, the transaction machine 620 is configured to authenticate a transaction machine user based at least partially on an ATM/debit/credit card, loyalty/rewards/club card, smart card, token (e.g., USB token), username/password, PIN, biometric information, and/or one or more other credentials that the user presents to the transaction machine 620. Additionally or alternatively, in some embodiments, the transaction machine 620 is configured to authenticate a user by using one-, two-, or multi-factor authentication. For example, in some embodiments, the transaction machine 620 requires two-factor authentication, such that the transaction machine user must provide a valid debit card and enter the correct PIN associated with the debit card in order to be authenticated to the transaction machine 620.

As illustrated in FIG. 6, the transaction machine 620 includes a communication interface 622, a processor 624, a memory 626 having a transaction application 627 stored therein, and a user interface 629. In such embodiments, the processor 624 is operatively connected to the communication interface 622, the user interface 629, and the memory 626. Each communication interface described herein, including the communication interface 622, generally includes hardware and/or software that enable a portion of the system 600, such as the transaction machine 620, to send, receive, and/or otherwise communicate information to and/or from the communication interface of one or more other portions of the system 600. For example, the communication interface 622 of the transaction machine 620 may include a modem, network interface controller (NIC), network adapter, network interface card, and/or some other electronic communication device that operatively connects the transaction machine 620 to another portion of the system 600.

Each processor described herein, including the processor 624, generally includes circuitry for implementing the audio, visual, and/or logic functions of that portion of the system 600. For example, the processor may include a digital signal processor device, a microprocessor device, and/or various analog-to-digital converters, digital-to-analog converters, and/or other support circuits. Control and signal processing functions of the apparatus in which the processor resides may be allocated between these one or more devices according to their respective capabilities. The processor may also include functionality to operate one or more software programs based at least partially on computer-executable program code portions thereof, which may be stored, for example, in a memory device, such as in the transaction application 627 of the memory 626.

Each memory device described herein, including the memory 626 for storing the transaction application 627 and other information, may include any computer-readable medium. For example, the memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more portions of information used by the apparatus in which it resides to implement the one or more functions of that apparatus. The memory may be non-transitory or transitory.

As shown in FIG. 4, the memory 626 includes the transaction application 627. The transaction application 627 can be operable (e.g., by the processor 624, by the transaction machine 620, and the like) to perform any one or more of the functions described herein as being performed by “an apparatus,” by the transaction machine 620, and/or by the transaction application 627. Additionally or alternatively, the transaction application 627 can be operable to initiate, execute, complete, and/or otherwise facilitate any portion of any embodiment described and/or contemplated herein, such as, for example, one or more of the portions of the process flows 100, 200, 300, 400, and/or 500 described herein. For example, in some embodiments, the transaction application 627 is operable to receive information associated with a transaction, where the transaction involves a deposit account. As another example, in some embodiments, the transaction application 627 is operable to determine an available balance, estimated balance, total amount delayed, and/or credit pending amount associated with a deposit account. As still another example, in some embodiments, the transaction application 627 is operable to post information to an online banking account, such as, for example, an available balance, an estimated balance, a description of a transaction, a transaction amount associated with a transaction, and/or the like. In some embodiments, the transaction application 627 includes a web browser and/or some other application for communicating with, navigating, controlling, configuring, and/or using the transaction processing apparatus 630, the processing application 637, and/or one or more other portions of the system 600.

In some embodiments, where the transaction machine 620 includes and/or is embodied as an ATM, the transaction application 627, when executed by the ATM, causes the ATM to initiate, perform, complete, and/or facilitate, for example, one or more cash withdrawals, deposits, and/or other ATM transactions. In other embodiments, where the transaction machine 620 includes and/or is embodied as a POS device, the transaction application 627, when executed by the POS device, causes the POS device to initiate, perform, complete, and/or facilitate, for example, one or more debit card transactions and/or other POS device transactions. In still other embodiments, where the transaction machine 620 includes and/or is embodied as a personal computer, the transaction application 627 is configured to execute on the personal computer, and, in some embodiments, the transaction application 627 is embodied as a web browser that is operable navigate the web and/or to initiate, perform, complete, and/or otherwise facilitate one or more financial and/or non-financial transactions. It will be understood that the transaction application 627 can be operable to initiate, authorize, make pending, facilitate, hold, delay, post, clear, finalize, and/or reconcile one or more financial and/or non-financial transactions.

In some embodiments, the account holder 605 can use the transaction application 627 to access the online banking account 609. In some embodiments, the transaction application 627 is created, provided, controlled, and/or maintained by the financial institution that maintains the transaction processing apparatus 630. For example, in some embodiments, the transaction machine 620 is embodied as a smart phone, and the transaction application 627 is embodied as a mobile banking “app” that was created by the financial institution and/or by a software maker for execution on the smart phone. As another example, in some embodiments, the account holder 605 can use the transaction application 627 to send identification and/or authentication information to the transaction processing apparatus 630, so that, for example, the transaction processing apparatus 630 can authenticate the account holder 605 and initiate, execute, complete, and/or otherwise facilitate any of the functions described and/or contemplated herein. Of course, the transaction application 627 can include one or more computer-executable program code portions for instructing and/or causing the processor 624 to perform one or more of the functions of the transaction application 627 and/or of the transaction machine 620 described and/or contemplated herein. In some embodiments, the transaction application 627 includes and/or uses one or more network and/or system communication protocols.

As shown in FIG. 6, the transaction machine 620 also includes the user interface 629. It will be understood that the user interface 629 can include and/or be embodied as one or more user interfaces. It will also be understood that, in some embodiments, the user interface 629 includes one or more user output devices for presenting information and/or one or more items to the transaction machine user (e.g., the account holder 605, and the like), such as, for example, one or more displays, speakers, receipt printers, dispensers (e.g., cash dispensers, ticket dispensers, merchandise dispensers, and the like), and/or the like. In some embodiments, the user interface 629 additionally or alternatively includes one or more user input devices, such as, for example, one or more buttons, keys, dials, levers, directional pads, joysticks, keyboards, mouses, accelerometers, controllers, microphones, touchpads, touchscreens, haptic interfaces, scanners, biometric readers, motion detectors, cameras, card readers (e.g., for reading the magnetic strip on magnetic cards such as ATM, debit, credit, and/or bank cards, and the like), deposit mechanisms (e.g., for depositing checks and/or cash, and the like), and/or the like for receiving information from one or more items and/or from the transaction machine user. In some embodiments, the user interface 629 and/or the transaction machine 620 includes one or more vaults, security sensors, locks, and/or anything else typically included in and/or near the transaction machine.

FIG. 6 also illustrates a transaction processing apparatus 630, which may include any computerized apparatus that can be configured to perform any one or more of the functions of the transaction processing apparatus 630 described and/or contemplated herein. The transaction processing apparatus 630 can include and/or be embodied as any apparatus described and/or contemplated herein. Also, the transaction processing apparatus 630 can initiate, perform, complete, and/or otherwise facilitate any transaction described and/or contemplated herein as being initiated, performed, and/or otherwise facilitated by an apparatus. In some embodiments, the transaction processing apparatus 630 includes and/or is embodied as one or more servers, engines, mainframes, personal computers, ATMs, network devices, front end systems, back end systems, and/or the like. In some embodiments, such as the one illustrated in FIG. 6, the transaction processing apparatus 630 includes a communication interface 632, a processor 634, and a memory 636, which includes a processing application 637 and a processing datastore 638 stored therein. As shown, the communication interface 632 is operatively connected to the processor 634, which is operatively connected to the memory 636.

The processing application 637 can be operable (e.g., by the processor 634, by the transaction processing apparatus 630, and the like) to perform any one or more of the functions described herein as being performed by “an apparatus,” by the transaction processing apparatus 630, and/or by the processing application 637. The processing application 637 can be operable to initiate, perform, complete, and/or facilitate any one or more portions of one or more of the embodiments described and/or contemplated herein, such as, for example, any one or more portions of the process flows 100, 200, 300, 400, and/or 500 described herein. For example, in some embodiments, the processing application 637 is operable to receive information associated with a transaction, where the transaction involves a deposit account (e.g., the deposit account 607, and the like). As another example, in some embodiments, the processing application 637 is operable to determine an available balance for a deposit account. As still another example, the processing application 637 is operable to determine whether an available balance for a deposit account is based at least partially on a transaction involving the deposit account. As another example, in some embodiments, the processing application 637 is operable to post information to an online banking account (e.g., the online banking account 609, and the like), such as, for example, an available balance, an estimated balance, a credit pending amount, a total amount delayed, a description of a transaction, a transaction amount associated with a transaction, and/or the like. In some embodiments, the processing application 637 is operable to render and/or paint one or more browser pages of an online banking account. As yet another example, in some embodiments, the processing application 637 is operable to post information to an online banking account associated with a deposit account, where, for example, the information indicates that an available balance for the deposit account is based at least partially on a first group of transactions but not based on a second group of transactions.

As another example, in some embodiments, the processing application 637 is operable to determine an estimated balance for a deposit account and/or to post the estimated balance to an online banking account. As another example, the processing application 637 can be operable to post information to an online banking account associated with a deposit account, where the information is associated with a deposit transaction having a total deposit amount, where the deposit transaction involves the deposit account, and where the information indicates that a first amount of the total deposit amount is immediately available and/or that a second amount of the total deposit amount is not immediately available.

In some embodiments, the processing application 637 is operable to enable the transaction processing apparatus 630 to communicate with one or more other portions of the system 600, such as, for example, the processing datastore 638 and/or the transaction machine 620, and/or vice versa. In addition, in some embodiments, the processing application 637 is operable to initiate, authorize, make pending, facilitate, hold, delay, post, clear, finalize, and/or reconcile one or more financial and/or non-financial transactions. In some embodiments, the processing application 637 includes one or more computer-executable program code portions for causing and/or instructing the processor 634 to perform one or more of the functions of the processing application 637 and/or the transaction processing apparatus 630 that are described and/or contemplated herein. In some embodiments, the processing application 637 includes and/or uses one or more network and/or system communication protocols.

In addition to the processing application 637, the memory 636 also includes the processing datastore 638. It will be understood that the processing datastore 638 can be configured to store any type and/or amount of information. For example, in some embodiments, the processing datastore 638 includes information typically associated with transactions, deposit accounts, online banking accounts, available balances, estimated balances, merchant category codes, rules, and/or the like. It will also be understood that the processing datastore 638 may include any one or more storage devices, including, but not limited to, one or more datastores, data repositories, databases, and/or other devices for storing information. The processing datastore 638 may store information in any known way, such as, for example, by using one or more computer codes and/or languages, alphanumeric character strings, data sets, figures, tables, charts, links, documents, and/or the like. Further, in some embodiments, the processing datastore 638 may include information associated with one or more applications, such as, for example, the processing application 637. In some embodiments, the processing datastore 638 provides a real-time or near real-time representation of the information stored therein, so that, for example, when the processor 634 accesses the processing datastore 638, the information stored therein is current or nearly current. The processing datastore 638 can also dynamically store information, such that the information stored therein (e.g., a list of merchant category codes) can be quickly and/or immediately added, deleted, changed, revised, updated, and/or the like.

Of course, the embodiment illustrated in FIG. 6 is exemplary and other embodiments may vary. For example, in some embodiments, some or all of the portions of the system 600 are combined into a single portion. Specifically, in some embodiments, the transaction machine 620 and the transaction processing apparatus 630 are combined into a single apparatus that is configured to perform all of the same functions as those separate portions as described and/or contemplated herein. Likewise, in some embodiments, some or all of the portions of the system 600 are separated into two or more distinct portions. For example, in some embodiments, the transaction processing apparatus 630 is divided into four separate, but operatively-connected apparatuses. In such embodiments, the first apparatus is configured to receive transaction information from a transaction involving a deposit account; the second apparatus is configured to determine, based at least partially on the transaction information, the estimated balance, available balance, credit pending amount, and/or total amount delayed for the deposit account; the third apparatus is configured to render one or more browser screens of an online banking account associated with the deposit account; and the fourth apparatus is configured to paint the one or more browser screens with the estimated balance, available balance, credit pending amount, and/or total amount delayed for the deposit account 607, and/or with information associated with the deposit account and/or transaction.

In some embodiments, the various portions of the system 600 may be maintained by the same or separate parties. For example, in some embodiments, a financial institution maintains the transaction processing apparatus 630, and the account holder 605 maintains the transaction machine 620. However, in other embodiments, a financial institution maintains both the transaction processing apparatus 630 and the transaction machine 620. Also, in some alternative embodiments, instead of the account holder 605, a banking associate, teller, customer service representative, and/or some other person maintains and/or has access to the transaction machine 620 in order to perform and/or otherwise facilitate the performance of one or more of the embodiments of the present invention.

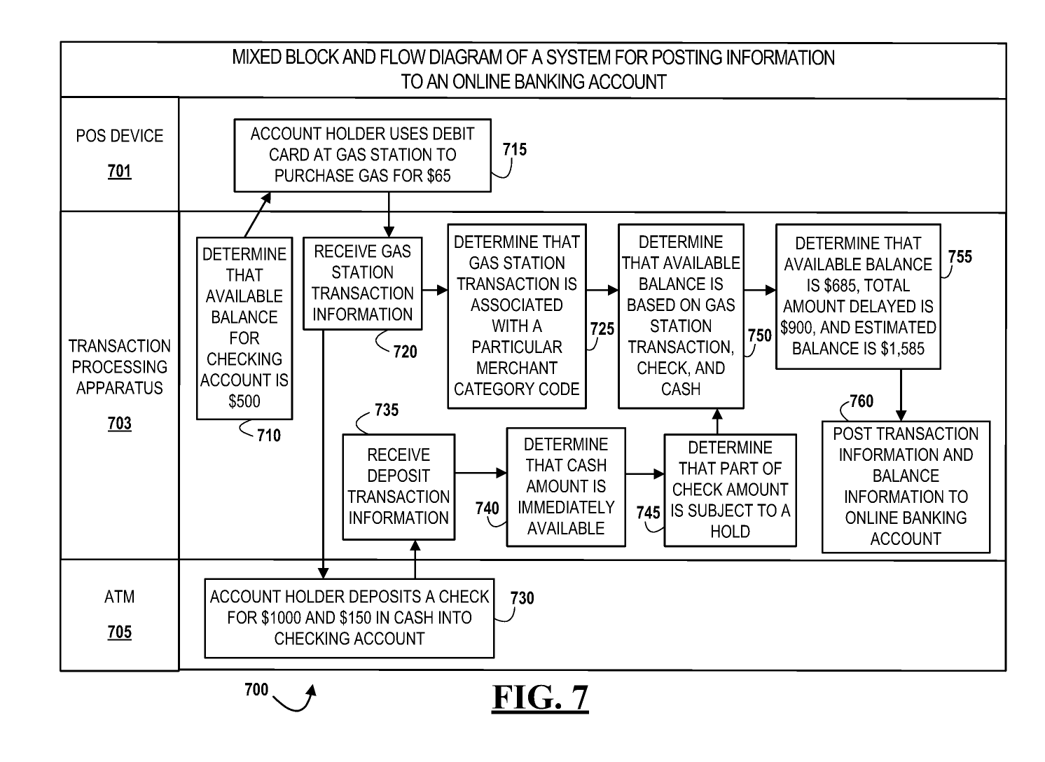

The system 600 (and/or one or more portions of the system 600) may include and/or implement any embodiment of the present invention described and/or contemplated herein. For example, in some embodiments, the system 600 (and/or one or more portions of the system 600) is configured to implement any one or more embodiments of the process flow 100 described and/or contemplated herein in connection with FIG. 1, any one or more embodiments of the process flow 200 described and/or contemplated herein in connection with FIG. 2, any one or more embodiments of the process flow 300 described and/or contemplated herein in connection with FIG. 3, any one or more embodiments of the process flow 400 described and/or contemplated herein in connection with FIG. 4, any one or more embodiments of the process flow 500 described and/or contemplated herein in connection with FIG. 5, any one or more embodiments of the system 700 described and/or contemplated herein in connection with FIG. 7, and/or any one or more embodiments described and/or contemplated herein in connection with FIG. 8.

As a specific example, the transaction processing apparatus 630 can be configured to: (1) receive information associated with the deposit account 607 from the transaction machine 620, as represented by block 310 in FIG. 3; (2) determine, based at least partially on the information associated with the deposit account 607, an available balance associated with the deposit account 607, as represented by block 320; (3) determine, based at least partially on the information associated with the deposit account 607, a second amount associated with the deposit account 607, as represented by block 330; (4) determine, based at least partially on the available balance and the second amount, an estimated balance associated with the deposit account 607, as represented by block 340; and (5) post the estimated balance, available balance, and/or second amount to the online banking account 609, as represented by block 350. In accordance with some embodiments, the transaction machine 620 and the transaction processing apparatus 630 are each configured to send and/or receive information (e.g., data, images, messages, instructions, and the like) to and/or from each other, such that information sent from a first apparatus to a second apparatus can trigger that second apparatus to perform one or more portions of any one or more of the embodiments described and/or contemplated herein.

Referring now to FIG. 7, a mixed block and flow diagram of a system 700 for posting information to an online banking account is provided, in accordance with an embodiment of the present invention. As shown, the system 700 includes a POS device 701, a transaction processing apparatus 703, and an ATM 705. The POS device 701 and the ATM 705 may each include a communication interface, a user interface, a processor, a memory, an application, and/or a datastore, and those devices may be operatively connected to each other.

In this example embodiment, the POS device 701 and the ATM 705 are operatively connected to the transaction processing apparatus 703 via one or more networks (not shown). Also, the POS device 701 and the ATM 705 are accessible to the account holder referred to in blocks 715, 730, and 765. The POS device 701 is maintained by a gas station merchant, and the transaction processing apparatus 703 and the ATM 705 are each maintained by a bank. The bank also maintains the checking account referred to in block 710 and the online banking account referred to in block 760, and the account holder is a customer of the bank. Also, in this example embodiment, the bank maintains the online banking account and the checking account associated with the debit card referred to in block 715. In addition, the account holder has access to the checking account, the online banking account, the POS device 701, and the ATM 705.

As represented by block 710, the transaction processing apparatus 703 determines that the available balance for the checking account is $500. Thereafter, as represented by block 715, the account holder uses the debit card associated with the checking account to purchase gas at a gas station for $65 (e.g., by swiping the debit card through the POS device 701). Then, the transaction processing apparatus 703 receives information associated with the gas station transaction, for example, as part of an authorization request, as represented by block 720. The gas station transaction information may include a transaction amount, the one or more parties involved in the transaction, the type of the transaction, a merchant category code associated with the transaction, a description of the transaction, and/or the like.

After the transaction processing apparatus 703 receives the gas station transaction information, the apparatus 703 determines, based at least partially on the gas station transaction information, that the gas station transaction is associated with a particular merchant category code, as represented by block 725. For example, in some embodiments, the apparatus 703 determines that the gas station transaction is associated with the merchant category code “5541” for service stations. In some embodiments, the apparatus 703 receives the merchant category code in the gas station transaction information, but in other embodiments, the apparatus 703 determines the merchant category code by accessing a datastore having one or more merchant names and corresponding merchant category codes stored therein. Thereafter, as represented by block 750, the apparatus 703 determines that the available balance for the checking account is based at least partially on the gas station transaction because the gas station transaction is associated with the merchant category code “5541” for service stations. For example, in some embodiments, the apparatus 703 accesses a datastore having one or more merchant category codes and/or rules stored therein. In such embodiments, an exemplary rule may specify that an available balance is not based on any transaction associated with a first merchant category code (e.g., “3501” for a hotel) but that the available balance is based at least partially on any transaction associated with a second merchant category code (e.g., “5541” for service stations).

After the account holder engages in the gas station transaction, the account holder also engages in a deposit transaction at the ATM 705 by depositing a check for $1,000 and $150 in cash into the checking account, as represented by block 730. Thereafter, the transaction processing apparatus 703 receives information associated with the deposit transaction, as represented by block 735. The deposit transaction information may include, for example, the total deposit amount of the deposit transaction, the deposit amount of the check portion of the deposit transaction, the deposit amount of the cash portion of the deposit transaction, the date and time of the deposit transaction, the identity of the ATM involved in the deposit transaction, the identity of the account holder, the identity of the checking account, a description of the transaction, and/or the like.

After the transaction processing apparatus 703 receives the deposit transaction information, the apparatus 703 determines that the cash amount of the deposit transaction is immediately available, as represented by block 735. In some embodiments, the apparatus 703 makes this determination based at least partially on one or more rules that specify, for example, that cash amounts deposited into an ATM are always made immediately available. Additionally, the apparatus 703 determines that the check amount of the deposit transaction is subject to a hold. For example, the apparatus 703 may determine that the first $100 of the check is immediately available based at least partially on one or more government regulations, but that the remaining check amount is subject to a hold because the payor on the check has the same name as a person known to be involved in misappropriations. In some embodiments, the apparatus 703 is configured to make these determinations after accessing a datastore having one or more rules stored therein, where the one or more rules specify when an available balance is or is not based on a deposit amount associated with a deposit transaction. Thereafter, as represented by block 750, the apparatus 703 determines that the available balance for the checking account is based at least partially on the entire cash amount and the $100 check amount because both are immediately available. In addition, as represented by block 750, the apparatus 703 determines that the available balance is not based on the remaining check amount because that check amount is subject to a hold. Again, the apparatus 703 may access one or more rules in a datastore in order to make these determinations.

After determining which transaction amounts are included in the available balance and which are not, the transaction processing apparatus 703 determines the available balance, the total amount delayed, and the estimated balance associated with the checking account. In this example embodiment, the apparatus 703 determines that: (a) the available balance is $685 (i.e., $500 (starting available balance)−$65 (gas station transaction)+$150 (cash amount of deposit transaction)+$100 (first $100 of check amount)=$685); (b) the total amount delayed is $900 (i.e., the remaining check amount); and (c) the estimated balance is $1,585 (i.e., $685 (the available balance)+$900 (the total amount delayed)=$1,585).

Thereafter, the apparatus 703 is configured to post transaction information and/or balance information to an online banking account associated with the checking account. For example, in some embodiments, the apparatus 703 posts a description of the gas station transaction to a first portion of a transaction ledger in the online banking account, and also posts a description of the deposit transaction to a second portion of the transaction ledger. The apparatus 703 may also post information to the online banking account that indicates that the available balance is based at least partially on transactions described in the first portion of the transaction ledger, but that the available balance is not based on transactions described in the second portion of the transaction ledger. As still another example, in some embodiments, the apparatus 703 posts, to the online banking account, the $65 transaction amount of the gas station transaction, the $150 cash amount of the deposit transaction, and the $1,000 check amount of the deposit transaction. In such embodiments, for example, the apparatus 703 may also post information proximate to one or more (or each) of those transaction amounts to indicate whether those transaction amounts are included in the available balance, total amount delayed, credit pending amount, and/or estimated balance. As another example, in some embodiments, the apparatus 703 posts the available balance, the total amount delayed, the credit pending amount, and the estimated balance to the online banking account (e.g., to a “Balance Summary” portion in the online banking account), and the apparatus 703 also posts information to the online banking account (e.g., to and/or proximate to the Balance Summary portion) that describes how the estimated balance is calculated.

Of course, the embodiment illustrated in FIG. 7 is merely exemplary and other embodiments may vary without departing from the scope and spirit of the present invention. For example, in some alternative embodiments, the one or more portions of the process flow being performed by the transaction processing apparatus 703 are performed instead by the ATM 705. As another example, in some alternative embodiments, the system 700 involves a mobile phone instead of the POS device 701 (e.g., instead of swiping the debit card at a POS device, the user inputs the debit card information into an merchant application executing on the mobile phone). As still another example, in some alternative embodiments, the check amount of the deposit transaction is $15,000, and the apparatus 703 determines that the check amount is not subject to a hold but is also not immediately available because, for example, the check amount is so high that the check itself must be verified before the check amount is made immediately available. As yet another example, in some embodiments, the account holder uses the ATM 705, a mobile phone, a personal computer, and/or one or more other devices to access the online banking account and view the transaction and/or balance information posted thereto.

In some embodiments, the one or more of the portions of the process flow represented by blocks 710-760 are triggered by one or more triggering events, which, in some embodiments, include the performance of one or more of the other portions of the process flow represented by blocks 710-760. Also, in some embodiments, the system 700 is configured to perform one or more portions of the process flow represented by blocks 710-760 (and/or the entire process flow), from start to finish, within moments, seconds, and/or minutes. For example, in some embodiments, the apparatus 703 determines that the gas station transaction is associated with a particular merchant category code and determines that the available balance for the checking account is based at least partially on the gas station transaction because, for example, the gas station transaction is associated with the particular merchant category code, all within approximately 1-15 minutes of the apparatus 703 receiving the gas station transaction information.

Referring now to FIG. 8, an exemplary browser page 800 of an online banking account is illustrated, where the online banking account is associated with a checking account, and where the browser page 800 includes available balance information, estimated balance information, and deposit transaction-level information associated with the checking account, in accordance with an embodiment of the present invention. In this example embodiment, the browser page 800 is embodied as and/or includes one or more web pages (e.g., one or more HTML pages), intranet pages, pages associated with a dashboard application, pages associated with an online banking application, pages associated with a mobile banking application, and/or the like. The browser page 800 can be displayed, for example, on a display housed in a mobile phone, on a monitor associated with a personal computer, on a touchscreen display associated with an ATM, and/or the like. In this embodiment, the checking account and the online banking account are both maintained by a bank, and the holder of the checking account is a customer of the bank.

The browser page 800 can be configured to navigate to one or more other browser pages (not shown) or vice versa. In addition, the browser page 800 can include one or more browser pages and/or one or more features typically found in a browser page (e.g., selectable buttons, links, tabs, drop-down menus, pop-up windows, and the like). Also, in accordance with some embodiments, the apparatus configured to perform the process flow(s) 100, 200, 300, 400, and/or 500, the system 600 (and/or one or more of the underlying apparatuses), and/or the system 700 can be configured to implement any one or more embodiments of the present invention described and/or contemplated herein in connection with the browser page 800.

As shown in FIG. 8, the browser page 800 includes a transaction ledger 810 and a balance summary 840. The transaction ledger 810 has a posting date column 812, a transaction description column 814, a transaction type column 816, a transaction status column 818, a transaction amount column 820, and an available balance column 822. The transaction ledger 810 also includes several rows of transactions posted thereto, which are sometimes referred to herein as transaction ledger entries. As shown in FIG. 8, the transaction ledger 810 includes a car payment transaction 824, a check transaction 826, a payroll transaction 828, an ATM withdrawal transaction 830, a salon transaction 832, a restaurant transaction 834, an ATM deposit transaction 836, and a hotel transaction 838. Each transaction ledger entry includes information associated with an individual transaction, and that information is provided in accordance with the columns mentioned above. For example, the transaction ledger entry that corresponds to the payroll transaction 828 includes the following information associated with that transaction: the information in the transaction data column 812 indicates that the date the payroll transaction cleared to the online banking account was “Feb. 15, 2010,” the information in the transaction description column 814 indicates that the description for the payroll transaction is “Payroll ID: xxxxxxxxx,” the “+” sign in the transaction type column 816 indicates in the transaction was a credit transaction, the “C” box in the transaction status column 818 indicates that the transaction is a cleared transaction, the information in the transaction amount column 820 indicates that the amount credited to the checking account as a result of the payroll transaction 828 was “$1,250,” and the information in the available balance column 822 indicates that the payroll transaction 828 caused the available balance for the checking account to increase to “$1,625.27.”

As shown in FIG. 8, the transaction ledger 810 is divided into two, easy-to-understand portions: an “Amount not included in Available Balance” portion 850 and an “Amount included in Available Balance” portion 860. The Amount not included in Available Balance portion 850 is meant to indicate that the available balance is not based on the transactions described therein. In other words, the transaction amounts posted to the Amount not included in Available Balance portion 850 are not included in the available balance and are not immediately available. Similarly, the Amount included in Available Balance portion 860 is meant to indicate that the available balance is based at least partially on the transactions described therein. Said differently, the transaction amounts posted to the Amount included in Available Balance portion 860 are included in the available balance and are immediately available. As shown in FIG. 8, for example, the information associated with the hotel transaction 838 is posted to the Amount not included in Available Balance portion 850, and the information associated with the ATM deposit transaction 836 is posted to the Amount included in Available Balance portion 860. In accordance with some embodiments, the hotel transaction 838 is described in the Amount not included in Available Balance portion 850 based at least partially on a first merchant category code being associated with the hotel transaction 838, and the ATM deposit transaction 836 is described in the Amount included in Available Balance portion 860 based at least partially on its transaction type. Additionally or alternatively, in some embodiments, the hotel transaction 838 is described in the Amount not included in Available Balance portion 850 based at least partially on the hotel transaction 838 involving an over-authorizing merchant, that is, the hotel.

Also shown in the transaction ledger 810 is deposit transaction-level information. For example, the information associated with the ATM deposit transaction 836 that is posted to the transaction ledger 810 includes a total deposit amount 836A of “$300,” a available now amount 836B of “$100,” and a credit pending amount 836C of “$200,” where each of the amounts 836A, 836B, and 836C correspond to the ATM deposit transaction 836. In other words, the ATM deposit transaction 836 had a total deposit amount of $300, and $100 of that total deposit amount is immediately available, and the other $200 of that total deposit amount is not immediately available. In addition to including these amounts, the ATM deposit transaction ledger entry 836 includes information 836D that indicates when the credit pending amount will be available (i.e., “available to cover debits on 02/25 and for withdrawal the next business day”). Although the $200 amount is shown as a credit pending amount in FIG. 8, in some alternative embodiments, the $200 amount may be subject to a hold, and that hold may be recorded as a separate transaction ledger entry.

The browser page 800 also shows the balance summary 840. As shown, the balance summary 840 includes an available balance 842 of “$1,535.27,” a credit pending amount 844 of “$200,” and an estimated balance 846 of “$1,735.27.” The balance summary 840 also includes information indicating that the estimated balance is based at least partially on the available balance 842 and the credit pending amount 844. More specifically, in this example embodiment, the balance summary 840 shows a plus sign 843 and a summation line 841 that collectively indicate that the estimated balance 846 equals the sum of the available balance 842 and the credit pending amount 844. As such, the balance summary 840 provides a quick overview of the balance information for the checking account. The balance summary 840 also enables an account holder to view the balance summary 840, together with the information in the transaction ledger 810, in order to quickly and easily determine the available balance for the checking account, the estimated balance for the checking account, and how those balances are calculated. In addition, the available balance 842 in the balance summary 840 corresponds to the most recent entry in the available balance column 822, which shows that the information in the transaction ledger 810 matches the information in the balance summary 840. In some alternative embodiments, the balance summary 840 may show a total amount delayed instead of, or in addition to, the credit pending amount 844.

Although many embodiments of the present invention have been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, and the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, and the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for enhancing financial account balances, the system comprising:
a computer apparatus including a processor and a memory; and
an transaction software module stored in the memory, comprising executable instructions that when executed by the processor cause the processor to:
receive information associated with a first transaction, wherein the first transaction involves a deposit account, wherein an authorization request submitted by a first merchant for the first transaction comprises a transaction amount that is less than the amount the first merchant will actually apply, and wherein the first transaction is not cleared;
receive information associated with a second transaction, wherein the second transaction involves the deposit account, wherein an authorization request submitted by a second merchant comprises a transaction amount that is greater than the amount the second merchant will actually apply;
determine, based at least partially on the information associated with the first transaction, that an available balance associated with the deposit account is based at least partially on the first transaction and that a transaction amount associated with the first transaction is included in the available balance and is immediately available;
determine, based at least partially on the information associated with the second transaction, that the available balance is not based on the second transaction and that a transaction amount associated with the second transaction is not included in the available balance and is subject to a hold based on the number of deposits received in the deposit account during a period of time, wherein a total deposit amount of the received deposits is greater than a predetermined deposit maximum;
post first information to an online banking account, wherein the online banking account is associated with the deposit account, and wherein the first information indicates that the available balance is based at least partially on the first transaction; and
post second information to the online banking account, wherein the second information indicates that the available balance is not based on the second transaction.

2. The system of claim 1, wherein the executable instructions further cause the processor to:
determine the available balance associated with the deposit account; and
post the available balance to the online banking account.

3. The system of claim 1, wherein the executable instructions cause the processor to post the first information by:
posting a description of the first transaction to a first portion of the online banking account; and
posting information that indicates that the available balance is based at least partially on transactions described in the first portion of the online banking account, and
wherein the processor is configured to post the second information by:
posting a description of the second transaction to a second portion of the online banking account; and
posting information that indicates that the available balance is not based on transactions described in the second portion of the online banking account.

4. The system of claim 3, wherein the first portion of the online banking account comprises a first portion of a transaction ledger in the online banking account, and wherein the second portion of the online banking account comprises a second portion of the transaction ledger.

5. The system of claim 1, wherein the executable instructions cause the processor to post the first information by:
posting a transaction amount associated with the first transaction to the online banking account; and
posting information proximate to the transaction amount that indicates that the transaction amount is included in the available balance.

6. The system of claim 1, wherein the executable instructions cause the processor to post the first information by:
posting a transaction amount associated with the first transaction to a first portion of a transaction ledger in the online banking account; and
posting information that indicates that transaction amounts posted to the first portion of the transaction ledger are included in the available balance.

7. The system of claim 1, wherein the executable instructions further cause the processor to:
make the first determination based at least partially on the type of the first transaction; or
make the second determination based at least partially on the type of the second transaction.

8. The system of claim 1, wherein the executable instructions further cause the processor to:
make the first determination based at least partially on a determination that the first transaction is associated with a first merchant category code, or
make the second determination based at least partially on a determination that the second transaction is associated with a second merchant category code.

9. The system of claim 1, wherein the executable instructions further cause the processor to:
make the first determination based at least partially on a determination that the first transaction involves an under-authorizing merchant; or
make the second determination based at least partially on the based at least partially on a determination that the second transaction involves an over-authorizing merchant.

10. The system of claim 1, wherein the executable instructions cause the processor to make the first determination based at least partially on:
determining that the first transaction comprises a deposit transaction;
determining that the deposit transaction comprises a total deposit amount; and
determining that at least a portion of the total deposit amount is immediately available.

11. The system of claim 1, wherein the executable instructions cause the processor to make the second determination based at least partially on:
determining that the second transaction comprises a deposit transaction;
determining that the deposit transaction comprises a total deposit amount; and
determining that none of the total deposit amount is immediately available.

12. A computer program product for enhancing financial account balances, the computer program product comprising:
a non-transitory computer readable storage medium having computer readable program code embodied therewith, the computer readable program code comprising:
computer readable program code configured to receive information associated with a first transaction, wherein the first transaction involves a deposit account, wherein an authorization request submitted by a first merchant for the first transaction comprises a transaction amount that is less than the amount the first merchant will actually apply, and wherein the first transaction is not cleared;
computer readable program code configured to receive information associated with a second transaction, wherein the second transaction involves the deposit account, wherein an authorization request submitted by a second merchant comprises a transaction amount that is greater than the amount the second merchant will actually apply;
computer readable program code configured to determine, based at least partially on the information associated with the first transaction, that an available balance associated with the deposit account is based at least partially on the first transaction and that a transaction amount associated with the first transaction is included in the available balance and is immediately available;
computer readable program code configured to determine, based at least partially on the information associated with the second transaction, that the available balance is not based on the second transaction and that a transaction amount associated with the second transaction is not included in the available balance and is subject to a hold based on the number of deposits received in the deposit account during a period of time, wherein a total deposit amount of the received deposits is greater than a predetermined deposit maximum;
computer readable program code configured to post first information to an online banking account, wherein the online banking account is associated with the deposit account, and wherein the first information indicates that the available balance is based at least partially on the first transaction; and
computer readable program code configured to post second information to the online banking account, wherein the second information indicates that the available balance is not based on the second transaction.

13. The computer program product of claim 12, further comprising computer readable program code configured to determine the available balance associated with the deposit account and post the available balance to the online banking account.

14. The computer program product of claim 12, further comprising computer readable program code configured to post a transaction amount associated with the first transaction to the online banking account; and post information proximate to the transaction amount that indicates that the transaction amount is included in the available balance.

15. The computer program product of claim 12, further comprising computer readable program code configured to:
post the first information by posting a transaction amount associated with the first transaction to a first portion of a transaction ledger in the online banking account and posting information that indicates that transaction amounts posted to the first portion of the transaction ledger are included in the available balance; and
post the second information by posting a transaction amount associated with the second transaction to a second portion of the transaction ledger; and posting information that indicates that transaction amounts posted to the second portion of the transaction ledger are not included in the available balance.

16. The computer program product of claim 12, further comprising computer readable program code configured to make the first determination based at least partially on the type of the first transaction or make the second determination based at least partially on the type of the second transaction.

17. A computer implemented method for enhancing financial account balances, the method comprising:
receiving, at a computing device, information associated with a first transaction, wherein the first transaction involves a deposit account, wherein an authorization request submitted by a first merchant for the first transaction comprises a transaction amount that is less than the amount the first merchant will actually apply, and wherein the first transaction is not cleared;
receiving, at a computing device, information associated with a second transaction, wherein the second transaction involves the deposit account, wherein an authorization request submitted by a second merchant comprises a transaction amount that is greater than the amount the second merchant will actually apply;
determining, by a processor and based at least partially on the information associated with the first transaction, that an available balance associated with the deposit account is based at least partially on the first transaction and that a transaction amount associated with the first transaction is included in the available balance and is immediately available;
determining, by a processor and based at least partially on the information associated with the second transaction, that the available balance is not based on the second transaction and that a transaction amount associated with the second transaction is not included in the available balance and is subject to a hold based on the number of deposits received in the deposit account during a period of time, wherein a total deposit amount of the received deposits is greater than a predetermined deposit maximum;
posting, by a processor, first information to an online banking account, wherein the online banking account is associated with the deposit account, and wherein the first information indicates that the available balance is based at least partially on the first transaction; and
posting, by a processor, second information to the online banking account, wherein the second information indicates that the available balance is not based on the second transaction.

18. The method of claim 17, further comprising:
determining, by a processor, the available balance associated with the deposit account; and
posting, by a processor, the available balance to the online banking account.

19. The method of claim 17, wherein the posting the first information comprises:
posting, by a processor, a description of the first transaction to a first portion of the online banking account; and
posting, by a processor, information that indicates that the available balance is based at least partially on transactions described in the first portion of the online banking account, and
wherein the posting the second information comprises:
posting, by a processor, a description of the second transaction to a second portion of the online banking account; and
posting, by a processor, information that indicates that the available balance is not based on transactions described in the second portion of the online banking account.

20. The method of claim 19, wherein the first portion of the online banking account comprises a first portion of a transaction ledger in the online banking account, and wherein the second portion of the online banking account comprises a second portion of the transaction ledger.
